(19) United States
(12) Patent Application Publication
(10) Pub. No.: US 2019/0027724 A1
(43) Pub. Date: Jan. 24, 2019

(54) Electrochemical Energy Storage Devices and Methods of Making and Using the Same

(71) Applicant: ADA Technologies, Inc., Littleton, CO (US)

(72) Inventor: Weibing Xing, Littleton, CO (US)

(73) Assignee: ADA Technologies, Inc., Littleton, CO (US)

(21) Appl. No.: 15/821,092

(22) Filed: Nov. 22, 2017

Related U.S. Application Data
(60) Provisional application No. 62/435,477, filed on Dec. 16, 2016.
(60) Provisional application No. 62/430,530, filed on Dec. 6, 2016.
(60) Provisional application No. 62/430,528, filed on Dec. 6, 2016.
(60) Provisional application No. 62/430,525, filed on Dec. 6, 2016.

(51) Int. Cl. H01M 2/16; H01M 4/40; H01M 10/0562; H01M 10/052

(52) U.S. Cl. CPC H01M 2/166; H01M 2/1686; H01M 2300/0071; H01M 10/0562; H01M 10/052; H01M 4/405

(57) ABSTRACT

The disclosure relates to advanced energy storage devices. Some embodiments include a separator that can prevent an internal short circuit leading to uncontrolled thermal runaway. The disclosure also includes methods for making and using the separators. Some embodies describe an entirely solid-state battery having a high-energy density. The battery can have a high specific capacity lithium metal anode with little, if any, lithium dendrite formation and/or penetration. The battery is devoid of liquid organic solvents. Some embodiments describe an electrochemical energy storage device having power requirements and an enabling power source possessing one or more of a usable form factor, a minimal rate of self-discharge, relatively low internal resistance to minimize battery polarization and an amenable rate capability and function over the requisite temperature range. Some embodiments describe a metal-sulfur battery electrochemical energy storage device and methods of making and using the same.

### CROSS REFERENCE

The present application claims the benefits of U.S. Provisional Application Ser. Nos. 62/430,525, filed Dec. 6, 2016, entitled “Nanocomposite Membranes for Electrochemical Energy Storage Devices and Methods of Making and Using the Same,” 62/430,528, filed Dec. 6, 2016, entitled “Entirely Solid State Batteries and Methods of Making and Using the Same,” 62/430,530, filed Dec. 6, 2016, entitled “Long Life Low Voltage Batteries and Methods of Making and Using the Same,” and 62/435,477, filed Dec. 16, 2016, entitled “Metal-Sulfur Battery and Methods of Making and Using the Same”, each of which is incorporated herein in its entirety by this reference.

### STATEMENT REGARDING FEDERALLY SPONSORED RESEARCH OR DEVELOPMENT

Some of the disclosed invention was developed under the following U.S. Government Contracts: Contract No. N68335-16-C-0253, Office of Naval Research.

### FIELD

This disclosure relates generally to electrochemical energy storage devices. Particularly, to nanoporous separators positioned between electrodes comprising electrochemical energy storage devices and methods of making and using the same.

### BACKGROUND

The single greatest need for electrochemical energy storage devices has always been ever increasing high energy densities (e.g., batteries and supercapacitors). The safety and reliability of these high energy source devices have become increasingly important as they increase in size to meet demand.

Separators used in energy storage devices, e.g., batteries or supercapacitors, play an important and critical role in physically and electronically separating the anode and cathode but permitting ion transport, such as lithium-ion transport in lithium-ion energy storage devices. An energy storage device separator should also provide one or more of a thermal shutdown mechanism, and prevent formation of lithium dendrites or other defects in the cell from penetrating the membrane. Such events can cause an internal short circuit leading to uncontrolled thermal runaway.

The challenge with designing an effective energy storage device separator is centered in a trade-off between mechanical durability and porosity/transport properties. For example, high separator tortuosity, τ, defined as τ=lₛ/d where is lₛ the ion path through the separator and d is separator thickness, is good for dendrite resistance but it can also lead to a higher separator resistance. Separator design is further complicated by additional constraints including tolerance to abuse conditions, high voltage stability (e.g., 4 volts or more), and chemical stability to other cell materials, while also meeting aggressive cost targets (i.e., no more than about $1/m²). The development of advanced energy storage device separators will benefit current and future defense and commercial applications, such as electric drive vehicles, medical applications, consumer electronics and space applications.

The safety and reliability of these high energy electrochemical energy devices have become increasingly important as they increase in size to meet demand. The challenge with designing solid-state batteries are operation at room temperatures and below. Solid-state batteries also commonly comprise electrolytes having low ionic conductivity and high electrode-electrolyte interface impedance. The high impedance generally reduces one or more of the capacity, energy density, rate capability of the electrochemical device. The high impedance can also diminish the low temperature performance of the electrochemical device.

A need exists for solid-state electrochemical energy storage device having improved capacity, energy density, rate capability at room and lower temperatures, long cycle life potentials and a wide electrochemical voltage range. Further needs also include improved safety, preferably without the need of organic solvents and without a fuel that contributes to thermal runaway.

Recent advancements in sub-threshold circuits enable low voltage sensor systems to overcome persistent sensing power limitations by developing wireless, event-driven sensing capabilities. This permits a low voltage sensor to remain dormant—effectively asleep yet aware—until an event of interest activates the sensor. The diminished power consumption increases sensor lifetime and practical use by assuaging the need for power sources to be replaced or recharged; a process that is time-consuming, costly and, in military situations, dangerous. Sub-threshold circuit developments afford significant advancements in reduced electronic power consumption (as low as 10 nW). Sub-threshold circuits however operate on supply voltages below 1 V (e.g., 0.3-0.7 V). Since, commercial small battery and (related) power sources are limited to output voltages greater than 1.2 V, they require external components such as regulators to produce stable supply voltages less than 1 V. Unfortunately, voltage regulators are energy inefficient and defeat the purpose of low energy demand sensors. The development of novel power sources to provide a sustained, stable requisite voltage for sub-threshold circuits will increase the unattended sensors' mission lifetime.

In addition to the power requirements, an enabling power source should possess a usable form factor, a minimal rate of self-discharge, relatively low internal resistance to minimize battery polarization and provide an amenable rate capability and function over the requisite temperature range. Finally, the power source should be minimally toxic and/or make use of renewable materials.

Due to their higher specific capacity and energy compared to nickel-cadmium and lead-acid batteries, lithium-ion batteries are the battery of choice as power sources for many military and civilian applications. Typically, a lithium transition-metal oxide or phosphate intercalates the lithium ions within the battery at a high potential with respect to a carbon negative electrode.

Theoretically, sulfur can host more lithium ions than the conventional transition-metal oxide or phosphate intercalates of the current lithium-ion batteries, since each sulfur atom can host two lithium ions, compared with 0.5 to 0.7 lithium ions per conventional host atom. The lithium-sulfur redox couple reaction differs from that of conventional lithium-ion batteries in that the high capacity and recharge ability of sulfur can be achieved from the electrochemical cleavage and reformation of a sulfur-sulfur bond in the cathode. This increased lithium ion host capability can increase, based on cathode active material, one or more of battery specific capacity and specific energy (or energy density).

However, there are no lithium-sulfur batteries available today. This is because the actual chemical processes of Li—S battery are far more complex than the simple redox equation:

S₈+16Li⁺+16e⁻↔8Li₂S (1)

The complexity arises from the formation of lithium polysulfides which are reduced on the cathode surface in sequence while the cell is discharged; and a reverse reaction sequence that occurs when the cell is recharged. These reactions, and other battery performance issues, give rise to low practical energy yield, loss of capacity with cycling, high self-discharge rates and poor cycle coulombic efficiency, which also give rise to safety concerns. Lithium-sulfur cells of the prior art use of microscale commercial Li₂S or S powders and achieve mere fractions of the lithium-sulfur battery performance potential. Some of these prior art cells showed promise, surviving 500 to 2000 cycles with a small capacity fade from 0.02 to 0.99% per cycle.

### SUMMARY

Some embodiments include a solid-state electrochemical energy storage device, comprising

a first electrode;

a second electrode;

a separator positioned between the first and second electrode; and

a solid-state electrolyte in electrolytic contact with the separator, and the first and second electrodes, wherein the separator comprises a polyethylene polymer, lithium hexafluorophosphate and solid electrolyte ceramic filler and wherein the solid-state electrolyte comprising a sold electrolytic ceramic filler.

Some embodiments include a long-life, low voltage battery comprising:

a cathode comprising a lithium-tin alloy having one or more of the following compositions Sn, Li₂Sn₅, LiSn, Li₁₃Sn₅, Li₇Sn₂ and Li₂₂Sn₅ and one or more of an atomic-deposited layer of a cathode active material and a conductive additive;

an anode;

a separator positioned between the cathode and anode; and

an electrolyte in electrolytic contact with the separator, and the cathode and anode.

Some embodiments include a metal-sulfur battery, comprising:

a cathode comprising powdered sulfur having atomic-deposited layer of a cathode active material and one or more conductive additives;

an anode;

a separator having one or more atomic-deposited and molecular-deposited layers, wherein the separator is positioned between the cathode and anode; and

an electrolyte in electrolytic contact with the separator, and the cathode and anode.

Some embodiments include a nanocomposite separator for electrochemical storage devices, composing:

a functionalized block copolymer substrate;

one or more atomic-deposited and molecular-deposited layers positioned on the functionalized block copolymer substrate; and

one or more nanoceramic materials incorporated into the functionalized block copolymer substrate; and

one or more microporous separator with high porosity and mechanical and thermal durability characteristics.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### DESCRIPTION OF THE DRAWINGS

These and other needs are addressed by the various embodiments and configurations of the present invention. The present invention, as described below, can provide a number of advantages depending on the particular configuration.

FIG. 1A depicts a coated nanoporous battery separator according to some embodiments of the present disclosure;

FIG. 1B depicts a coated nanoporous battery separator according to some embodiments of the present disclosure;

FIG. 1C depicts a battery separator according to the prior art;

FIG. 1D depicts a battery separator according to the prior art;

FIG. 2A depicts electrolyte wicking of for a separator of the prior art;

FIG. 2B depicts electrolyte wicking of for a separator according to some embodiments of the present disclosure;

FIG. 2C depicts electrolyte contact angle for a separator of the prior art;

FIG. 2D depicts electrolyte contact angle for a separator according to some embodiments of the present disclosure;

FIG. 3 depicts the cell voltage verse specific capacity of separator according to some embodiments of the present disclosure;

FIG. 4 depicts the cell voltage verse specific capacity of separator according to some embodiments of the present disclosure;

FIG. 5 depicts specific capacity versus cycle number of a separator according to some embodiments of the present disclosure;

FIG. 6 depicts the ultimate tensile strength of some separators according to some embodiments of the present disclosure;

FIG. 7 depicts the percent shrinkage of some separators according to some embodiments of the present disclosure;

FIGS. 8A-8C depict surface tension measurements of some separators according to some embodiments of the present disclosure;

FIG. 9A depicts a solid electrolyte membrane sheet according to some embodiment of the present disclosure;

FIG. 9B depicts a solid electrolyte disk according to some embodiments of the present disclosure;

FIG. 10 depicts a separator substrate according to some embodiments of the present disclosure;

FIG. 11 depicts a cathode according to some embodiments of the present invention;

FIG. 12 depicts cell voltage versus specific capacity of an electrochemical energy storage device according to some embodiments of the present disclosure;

FIG. 13 depicts specific capacity versus cycle number of an electrochemical energy storage device according to some embodiments of the present disclosure;

FIG. 14 depicts cell voltage versus specific capacity of a solid-state electrochemical energy storage device according to some embodiments of the present disclosure;

FIG. 15 depicts cell voltage versus specific capacity of a solid-state electrochemical energy storage device according to some embodiments of the present disclosure;

FIG. 16 depicts cell specific capacity versus cycle number of a solid-state electrochemical energy storage device according to some embodiments of the present disclosure;

FIG. 17A depicts cell voltage versus specific capacity of a long-life, low voltage electrochemical energy storage device according to some embodiments of the present disclosure;

FIG. 17B depicts cell voltage over the range of 0.3 to 0.7 V versus specific capacity of the electrochemical energy storage device of FIG. 17A;

FIG. 18 depicts cell voltage versus specific capacity of a long-life, low voltage electrochemical energy storage device according to some embodiments of the present disclosure;

FIG. 19 depicts cell voltage versus specific capacity of some long-life, low voltage electrochemical energy storage devices according to some embodiments of the present disclosure;

FIG. 20 depicts cell voltage versus specific capacity of a metal-sulfur electrochemical energy storage device according to some embodiments of the present disclosure;

FIG. 21 depicts coulombic efficiency versus cycle number of a metal-sulfur electrochemical energy storage device according to some embodiments of the present disclosure;

FIG. 22 depicts cell voltage versus specific capacity of some metal-sulfur electrochemical energy storage devices according to some embodiments of the present disclosure;

FIG. 23 depicts an electrochemical energy storage device according to some embodiments of the present disclosure;

FIG. 24 depicts cell voltage versus specific capacity of an electrochemical energy storage devices according to some embodiments of the present disclosure.

FIG. 25A depicts separator cell impedance as a function of temperature for electrochemical devices having separator cells according to some embodiments of the present disclosure;

FIG. 25B depicts separator cell impedance as a function of temperature for electrochemical devices having separator cells according to some embodiments of the present disclosure;

FIG. 26A depicts cell impedance verses temperature for separator cells according to some embodiments of the present disclosure;

FIG. 26B depicts separator melting temperature versus heating temperature ramp rate for a separator according to some embodiments of the present disclosure;

FIG. 27 depicts separator cell impedance versus temperature according to some embodiments of the present disclosure;

FIG. 28 depicts charge/discharge voltage versus specific capacity during formation of an electrochemical energy cell according to some embodiments of the present invention;

FIG. 29 depicts discharge capacity retention versus C rate for electrochemical storage devices having various separators according some embodiments of the present disclosure; and

FIG. 30 depicts discharge capacity retention versus cycle number for electrochemical storage devices having various separators according some embodiments of the present disclosure.

The accompanying drawings are incorporated into and form a part of the specification to illustrate several examples of the present invention(s). These drawings, together with the description, explain the principles of the invention(s). The drawings simply illustrate preferred and alternative examples of how the invention(s) can be made and used and are not to be construed as limiting the invention(s) to only the illustrated and described examples. Further features and advantages will become apparent from the following, more detailed, description of the various embodiments of the invention(s), as illustrated by the drawings referenced below.

### DETAILED DESCRIPTION OF THE DISCLOSURE

In accordance with some embodiment of the present disclosure is a solid-state electrochemical energy storage device. The electrochemical storage device can comprise a first electrode, a second electrode and a separator positioned between the first and second electrode. The first electrode is typically an anode. The second electrode is generally a cathode. Commonly, the separator is positioned between the anode and cathode. The separator can comprise a solid-state electrolyte. The solid-state electrolyte is generally in contact with one or more the first and second electrodes. More generally, the solid-state electrolyte is generally in contact with the anode and cathode. It can be appreciated that the contacting of the solid-state electrolyte with the anode and cathode establishes electrical and/or ionic conductivity between the anode and cathode.

In accordance with some embodiment of the present disclosure is a long-life, low voltage battery. The long-life, low voltage battery can have one or more of a high energy and high capacity. Moreover, the battery can be a long-life battery for low voltage applications.

The long-life, low voltage battery can comprise a first electrode, a second electrode and a separator positioned between the first and second electrode. Commonly, the separator is positioned between the anode and cathode. The separator can comprise a solid-state electrolyte. The solid-state electrolyte is generally in contact with one or more the first and second electrodes. More generally, the solid-state electrolyte is generally in contact with the anode and cathode. It can be appreciated that the contacting of the solid-state electrolyte with the anode and cathode establishes electrical and/or ionic conductivity between the anode and cathode. The first electrode is typically an anode. The second electrode is generally a cathode. The cathode generally comprises a high specific capacity tin electrode. The anode usually comprises a high capacity lithium electrode.

Metallic tin commonly possesses one of the highest discharge specific capacities. The specific capacity of metallic is usually below 1V, more usually between about 0.3 to about 0.7 Volts vs. Li, which generally corresponds to specific capacity of about 570 mAh/g. Such a lithium-tin electrochemical couple can be well suited ideal for low-voltage, high-energy applications. Moreover, a conformal, atomic layer deposited metal-oxide coating on the tin cathode can enhance the lithium-tin electrochemical couple, enabling one or more of the energy, capacity and stability of the electrochemical battery system.

Tin is relatively low in cost, non-toxic, abundant, moderate density (less dense than nearly all group 6-11 metals, but yet more than dense group 1A, 1B, 3B (Sc and Y), 3A (Al and Ga), 4A (Si and Ge) 5A (As and Sb), and 6A (Se, Te and Po) metals and metalloids) and commercially available, and lithium has a high specific capacity of 3,820 mAh/g. Metallic Sn is a lithium alloy material with a theoretical specific capacity of about 994 mAh/g, and more than about 60% of this capacity is delivered in the 0.3 to 0.7 Volt range. The lithium-tin binary phase diagram shows at room temperature eight distinct phases ranging from the lowest to the highest lithium concentration: Sn, Li₂Sn₅, LiSn, Li₇Sn₃, Li₅Sn₂, Li₁₃Sn₅, Li₇Sn₂, and Li₂₂Sn₅ (or Li_{4.4}Sn), which in it fully lithiated state, Li₂₂Sn₅, has a theoretical capacity of 994 mAh/g. While tin is a promising material for low voltage batteries, a number of technical challenges need to be overcome. For example, tin has a large volume expansion, at the maximum lithiated state, Li_{4.4}Sn, the volume expansion can be as high as 358%, which can result in particle cracking and loss of electrical contact. Also, the tin-lithium electrochemical couple possesses a low lithium ion diffusion coefficient of from about 10⁻¹⁶ to about 10⁻¹³ cm²/s. At least two factors severely limit specific capacity, power capability, performance at low temperatures and battery service life.

In accordance with some embodiment of the present disclosure is a metal-sulfur battery. The metal sulfur battery can comprise can a metal selected from the group consisting of lithium, sodium, magnesium, and a combination thereof. The metal-sulfur battery can comprise a first electrode, a second electrode and a separator positioned between the first and second electrode. The first electrode is typically an anode. The second electrode is generally a cathode. Commonly, the separator is positioned between the anode and cathode. The separator can comprise a solid-state electrolyte. The electrolyte is generally in contact with one or more the first and second electrodes. More generally, the electrolyte is generally in contact with the anode and cathode. It can be appreciated that the contacting of the anode and cathode establishes electrical and/or ionic conductivity between the anode and cathode. Generally, the metal-sulfur battery comprises a sulfur powder. The sulfur powder can be coated with an atomic-deposited layer of an active material. The active material can comprise aluminum oxide, Al₂O₃. The active material can comprise a mixture of alucone and aluminum oxide, Al₂O₃. In some embodiments, the battery comprises a sulfur composition comprising sulfur powder-conductive carbon-conductive graphite-binder composition. In some embodiments, the sulfur composition comprises 75 wt % sulfur powder, 15 wt % conductive carbon, 5 wt % conductive graphite and 5 wt % of a binder.

### Composite Solid-State Electrolyte Separator

In accordance with some embodiments, is a nanocomposite membrane/separator technology for energy storage devices, e.g., batteries or supercapacitors. The nanocomposite membrane/separator is based on a nanoceramic tailor-designed, functionalized block copolymer. The functionalized block copolymer can comprise a polyolefin. The nanocomposite separator is formed by atomic layer deposition, molecular layer deposition, or combined atomic and molecular layer deposition of composite on the functionalized block copolymer. The nanocomposite membrane technology possesses one or more desirable physical and safety features. The physical and safety features include without limitation one or more of uniformly distributed pores, robust mechanical properties, and exquisite tunability for separator thicknesses, pore size, porosity, melting point, tensile strength and wettability. These physical and safety features can be influenced by one or more of the block polymer composition, functional side chains or branches. Moreover, these physical and safety features can also be influenced by nanoceramic composite.

Polyethylene-based separators can generally have one or more of chemical and thermal stability. The polyethylene-based separator commonly comprises one of linear polyethylene or a polyethylene block co-polymer.

Block copolymers are a subclass of copolymers that consist of two or more chemically dissimilar homopolymer subunits connected at their termini. They can phase separate into ordered structures with nanoscale periodicity. The degree of block compatibility and phase separate can be described by the product of the degree of polymerization, n, and the Flory-Huggins interaction parameter, χ. Such polymeric materials can form separator materials with unprecedented properties that are not observed in a blend of the corresponding homopolymers. For example, a triblock copolymer of polylactide-b-polyethylene-b-polylactide (PLA-PE-PLA or LEL) exhibits elastomeric characteristics at low temperatures and melt-processable characteristics at elevated temperatures, whereas the analogous blends are known to macrophase separate resulting in poor mechanical properties.

Block copolymer morphologies also present unique opportunities, such as unique nanostructures for templating, delivery of functional groups, nanoscopic confinement and for separators and/or membranes. As for example, the selective removal of the polylactic acid (PLA) portion of a phase separated, PLA-b-PE-b-PLA block copolymer to realize a nanoporous solid.

In some embodiments, nanoceramic particles and/or fillers can be incorporated into the linear polyethylene-based separators. The particles and/or fillers incorporated into the nanoporous polyethylene-based separator by one or more of mixing, blending or dispersing nanoceramic particles and/or fillers. In some embodiments, the nanoceramic particles and/or fillers can be applied to the nanoporous polymeric separator by a conformal deposition of the ceramic material by one or more of atomic layer deposition, molecular layer deposition or a combination of atomic and molecular layer dispositions. The nanoceramic material can comprise metal-oxides. In some embodiments, a nanocomposite membrane can be formed by the inclusion of ceramic nanoparticles in a nanoporous polyolefin, such as nanoporous polyethylene. The nanoceramic material can enhance mechanical, chemical and electrochemical properties of nanoporous polymeric matrix. Moreover, nanocomposite membranes (or separators) can offer performance synergy, where there is an overall enhancement of separator properties and performance without any adverse effects.

In some embodiments, the nanoceramic material can be a metal oxide. The nanoceramic material can be selected from the group consisting of alumina (Al₂O₃), silica (SiO₂), titania (TiO₂), zirconia (ZrO₂), or a mixture thereof. The nanoceramic filler can comprise a ceramic material. In some embodiments, the ceramic material can be a solid electrolyte. The solid electrolyte can be selected from the group consisting of lithium aluminum oxide, lithium aluminum fluoride, lithium niobium oxide, or a mixture thereof. The nanoceramic filler can be in the form of a solid electrolyte filler. The solid electrolyte filler can be selected from the group consisting of an ionic conducting polymeric electrolyte, a solid-state electrolyte, or a mixture thereof.

The separator functional coating can be one or more protect and stabilize an electrochemical energy storage device. Moreover, the separator functional coating can one or more of enhance electrochemical performance and strengthen stabilities. The protection, stabilization and enhanced electrochemical performance and strengthen stabilities can increase long-term cycle life and storage life of the electrochemical energy storage device. The separator functional coating can be selected from the group consisting of metal oxides, metal nitrides, metal sulfides, metal phosphates, polymers, ion conducting electrolytes, solid electrolytes, a metal fluoride, a Garnet ion conductor, a sodium super ionic conductor, a lithium super ionic conductor, a sulfide having a lithium super ionic conductor structure, a lithium phosphorous nitrogen ion conductor, an alkali metal sulfide, an alkali metal oxide, an alkali metal aluminum oxide, an alkaline earth metal aluminum oxide, an alkali metal fluoride, an alkaline earth aluminum fluoride and mixtures thereof. The metal oxides can be selected from group consisting of an alkali metal aluminum oxide, an alkaline earth metal oxide, Al₂O₃, BaTiO₃, BaSrTiO₃, Bi₂O₃, Co₂O₃, FeOₓ Fe₃O₄, Ga₂O₃, HfO₂, In₂O₃, IrO₂, MnO₂, MoO₂, NiO, Ni(OH)₂, RuO₂, SiO₂, SnO₂, TiO₂, V₂O₅, Yb₂O₃, ZnO, ZrO₂, and mixtures thereof. The metal nitride can be selected from the group consisting of TiN, TaN, HfN, Hf₃N₄, Zr₃N₄, ZrNₓ, NbN, and mixtures thereof. The metal sulfide can be selected from the group consisting of PbS, ZnS, CaS, BaS, SrS, CuₓS, CdS, In₂S₃, WS₂, TiS₂, Sb₂S₃, SnS, GaSₓ, GeS, MoS₂, Li₂S, and mixtures thereof. The metal phosphate can be selected from the group consisting of AlPO₄, TiPO₄, FeAlPO₄, SiAlPO₄, CoAlPO₄MnAlPO₄, Li₃PO₄, NaH₂PO₄, and mixtures thereof.

In some embodiments, the ionic conducting solid electrolyte can be a lithium-ion conducting solid electrolyte. In some embodiments, the ion conducting solid electrolyte can be selected from the group consisting of a lithium-ion conducting electrolyte, a polymeric electrolyte, a solid-state electrolyte, or a mixture thereof. Generally, a polymeric electrolyte consists of an electrolyte salt incorporated in polymeric backbones.

In some embodiments, the lithium-ion electrolyte can be selected from the group consisting of lithium hexafluorophosphate, lithium hexafluoroarsenate, lithium perchlorate, lithium tetrafluoroborate, lithium trifluoromethane sulfonate, lithium bis(fluorosulfonyl)imide, lithium bis(trifluoromethanesulfonyl)imide, lithium bis(pentafluoroethylsulfonyl)imide, lithium tris(trifluoromethylsulfonyl)methide, lithium trifluoro tris(pentafluoroethyl)phosphate, lithium bis(oxalato)borate, lithium hexafluoroisopropoxide, lithium malonate borate, lithium difluoro(oxalato) borate, lithium hexafluoroantimonate, or a mixture thereof.

In some embodiments, a polymeric electrolyte can be selected from the group consisting of polyethylene oxide, polyacrylonitrile, polymethyl methacrylate, polyvinylidene fluoride, polyvinylidene fluoride, hexafluoropropylene, or a mixture thereof. In some embodiments, the ion conducting solid electrolyte can be selected from the group consisting of a metal oxide, a metal fluoride, a Garnet ion conductor, a sodium super ionic conductor, a lithium super ionic conductor, a sulfide having a lithium super ionic conductor structure, and a lithium phosphorous nitrogen ion conductor, or a mixture thereof.

In some embodiments, the ion conducting solid electrolyte can comprise one of a metal oxide or a metal fluoride selected from the group consisting of an alkali metal aluminum oxide, an alkali metal fluoride, an alkali metal sulfide, an alkaline earth metal oxide, an alkaline earth fluoride, or a mixture thereof.

In some embodiments, the ion conducting, solid electrolyte can be a chemical composition generally described the chemical formula M_{z}AlX_{y}, where M is one of alkali metal, X is one of oxygen or fluorine and z has a value from about 0.5 to about 10 and y has a value from about 1.75 to about 6.5. More specifically, z has a value from about 1 to about 5 and y has a value from about 2 to about 4.

In some embodiments, an alkali metal aluminum oxide solid electrolyte comprises lithium aluminum oxide, LiAlOₓ. The alkali metal aluminum solid electrolyte can have a Li:Al molar ratio selected from the group consisting of: 1:1, 1.5:1, 2:1, 2.5:1, 3:1, 3.5:1, 4:1, 4.5:1 and 5:1.

In some embodiments, the alkali metal oxide solid electrolyte can be lithium niobium oxide, LiₓNbO_{y}, where x has a value from about 1 to about 5 and y has a value from about 3 to 5.

In some embodiments, the Garnet solid electrolyte can be selected from the group consisting of Li₅La₃Ta₂O₁₂, Li₇La₃Zr₂O₁₂, Li₃Ln₃Te₂O₁₂, where Ln comprises a lanthanide or a mixture of lanthanides.

In some embodiments, the lithium super ionic conductor solid electrolyte can be selected from the group consisting of Li_{3.5}Zn_{0.25}GeO₄, Li_{3.4}Si_{0.4}V_{0.6}O₄, Li₂ZnGeO₄, Li₂₊₂ₓZn₁₋ₓGeO₄ where x has a value from about −0.36 to about 0.87, or a mixture thereof.

In some embodiments, the sulfide having a lithium super ionic conductor structure solid electrolyte can be selected from the group consisting of Li_{3.25}Ge_{0.25}P_{0.75}S₄, Li₁₀GeP₂S₁₂, Li₄₋ₓM_{1-y} M′_{y}S₄ (where M is one of Si, Ge, or a mixture thereof and where M′ is selected from the group consisting of P, Al, Zn, Ga), or a mixture thereof.

In accordance with some embodiments is a method for making the nanocomposite membrane/separator. The nanocomposite membrane and/or separator is generally formed by one or more nanoceramic materials and one or more polymeric materials being mixed, blended or dispersed at one or more of a molecular level, an atomic level, or a combination of molecular and atomic levels. It can be appreciated that method of forming the nanocomposite membrane and/or separator commonly includes the one or more nanoceramic materials and the one or more polymeric materials being chemically bonded to each other. More commonly, the one or more nanoceramic materials and the one or more polymeric materials are mixed conformally by one or more of a chemical vapor deposition process, a physical vapor deposition process, a chemical deposition process, an electrochemical deposition process, a spraying deposition process, a spin coating deposition process, an atomic layer deposition process, a molecular layer deposition process, or a combination thereof.

In accordance with some embodiments, the nanoporous separator and/or membrane can comprise the one or more nanoceramic materials coated on the one or more polymeric materials. The nanoporous separator and/or membrane can comprise one or more layers of the one or more nanoceramic materials deposited on one or more surfaces of the one or more polymeric materials. The coating and/or one or more layers of the one or more nanoceramic materials on the one or more polymeric materials can enhance mechanical, chemical and electrochemical properties the nanoporous separator and/or membrane. In some embodiments, the nanoporous separator and/or membrane can strengthen stabilities for long-term cycle life and storage life of energy storage devices, e.g., batteries and/or supercapacitors. The one or more nanoceramic materials can be selected from metal oxides, metal nitrides, metal sulfides, metal phosphates, polymers, and ion conducting and solid electrolytes. The metal oxide can be selected from the group consisting of Al₂O₃, BaTiO₃, BaSrTiO₃, Bi₂O₃, Co₂O₃, FeOₓ, Fe₃O₄, Ga₂O₃, HfO₂, In₂O₃, IrO₂, MnO₂, MoO₂, NiO, Ni(OH)₂, RuO₂, SiO₂, SnO₂, TiO₂, V₂O₅, Yb₂O₃, ZnO, ZrO₂, or a mixture thereof. The metal nitride can be selected from the groups consisting of TiN, TaN, HfN, Hf₃N₄, Zr₃N₄, ZrNₓ, and NbN, or a mixture thereof. The metal sulfide can be selected from the group consisting of PbS, ZnS, CaS, BaS, SrS, CURS, CdS, In₂S₃, WS₂, TiS₂, Sb₂S₃, SnS, GaSₓ, GeS, MoS₂, and Li₂S, or a mixture thereof. The metal phosphate can be selected from the group consisting of AlPO₄, TiPO₄, FeAlPO₄, SiAlPO₄, CoAlPO₄MnAlPO₄, Li₃PO₄, NaH₂PO₄, or a mixture thereof. The ion conducting polymer can be selected from the group consisting of polyimide, poly(fluorene), polyphenylenes, polypyrenes, polyazulene, polynaphthalenes, poly(acetylene), poly(p-phenylene vinylene), poly(pyrrole), polycarbazole, polyindole, polyazepine, polyaniline, poly(thiophene), poly(3,4-ethylenedioxythiophene), poly(p-phenylene sulfide), a poly(3,4-ethylenedioxythiophene), or a mixture thereof. The solid electrolyte can be selected from the group consisting of a metal oxide, a metal fluoride, a Garnet ion conductor, a sodium super ionic conductor, a lithium super ionic conductor, a sulfide having a lithium super ionic conductor structure, and a lithium phosphorous nitrogen ion conductor, or a mixture thereof. In some embodiments, the solid electrolyte can comprise one or more of a metal oxide or a metal fluoride selected from the group consisting of an alkali metal aluminum oxide, an alkali metal fluoride, an alkali metal sulfide, an alkaline earth metal oxide, an alkaline earth fluoride, or a mixture thereof. In some embodiments, the solid electrolyte can be represented by the chemical formula of M_{z}TX_{y}, where M can be an alkali metal, T can be one of aluminum or tungsten, X can be one of oxygen or fluorine and z can have a value from about 0.5 to about 10 and y can have a value from about 1.75 to about 6.5. In some embodiments, z can have a value from about 1 to about 5 and y can have a value from about 2 to about 4. In some embodiments, the alkali metal aluminum oxide can be represented by the chemical LiAlOₓ, where x has a value from about 1.75 to about 6.5. The alkali metal aluminum fluoride can comprises lithium aluminum fluoride, LiAlFₓ, where x has a value from about 1.75 to about 6.5. In some embodiments, the LiAlOₓ and LiAlFₓ can have a Li:Al molar ratio selected from the group consisting of: 1:1, 1.5:1, 2:1, 2.5:1, 3:1, 3.5:1, 4:1, 4.5:1 and 5:1. The alkali metal oxide can be selected from a group consisting of lithium niobium oxide, LiₓNbO_{y}, where x can have a value from about 1 to about 5 and y can have a value from about 3 to 5. The Garnet solid electrolyte can be selected from the group consisting of, e.g., Li₅La₃Ta₂O₁₂, Li₇La₃Zr₂O₁₂, Li₃Ln₃Te₂O₁₂ where Ln comprises a lanthanide, or a mixture of lanthanides. The lithium super ionic conductor can be selected from the group consisting of, e.g., Li_{3.5}Zn_{0.25}GeO₄, Li_{3.4}Si_{0.4}V_{0.6}O₄, Li_{z}ZnGeO₄, Li₂₊₂ₓZn₁₋ₓGeO₄ where x can have a value from about −0.36 to about 0.87, or a mixture thereof. The sulfide having a lithium super ionic conductor structure can be selected from the group consisting of Li_{3.25}Ge_{0.25}P_{0.75}S₄, Li₄₋ₓM_{1-y}M′_{y}S₄ (where M is one of Si, Ge, or a mixture thereof and where M′ is selected from the group consisting of P, Al, Zn, Ga), or a mixture thereof.

The composite solid-state electrolyte separator generally comprises a solid-electrolyte and polymeric matrix. The polymeric matrix is usually in the form of network. The polymeric matrix is generally an electrically insulating material. The polymeric matrix can incorporate and/or host a high ionic conducting solid-state electrolyte. The solid-state electrolyte can comprise a ceramic. The solid-state electrolyte can comprise a filler for the polymeric matrix.

In some embodiments, the composite solid-state electrolyte separator can comprise a flexible electronically insulating polymeric matrix and one or more of an ionic conducting salt and a high ionic conducting solid-state electrolyte. The solid-state electrolyte separator can comprise ion conducting material chemically bonded to the polymeric matrix. The polymeric matrix can be in the form of a polymeric network. The polymeric matrix is generally flexible. The polymeric matrix commonly comprises an electrically insulating material. The flexible electronically insulating, polymeric matrix is typically mixed with an ionic salt and a solvent to form a slurry. The slurry is cast and/or coated on polymeric matrix. After drying and/or curing of the slurry, the solid-state electrolyte bonded to the polymeric matrix to form the composite solid-state electrolyte separator. The solid-state polymeric electrolyte can comprise the ionic salt incorporated in polymeric matrix and/or polymeric backbone. The solvent can comprise a non-aqueous or an aprotic organic solvent. The organic solvent can be an aprotic organic solvent.

The composite electrolyte separator can be in form of membrane. Commonly, the polymeric matrix is in the form of membrane having one or more of a solid-state electrolyte filler and a solid-state electrolyte coating. The solid-state electrolyte separator of this disclosure can eliminate the bulky static fixtures and enclosures typically used in solid-state processes of the prior art. This reduces parasitic mass and improves energy density. The composite solid-State electrolyte separator generally comprises an ion conducting media for ion transport between the anode and the cathode. The composite solid-state electrolyte separator can also comprise an electronical insulating polymeric matrix. In some embodiments, the composite solid-state electrolyte separator can also physically separate the first and second electrodes from electronic shortage.

The composite solid-state electrolyte separator can be flexible. It can be appreciated that the flexible nature of the composite solid-state electrolyte separator can improve electrochemical energy storage device fabrication. The flexible nature of solid-state electrolyte separator can allow for conformal battery formats. The composite solid-state electrolyte separator can be less brittle and overcome the rigidity and difficult to handle solid electrolytes of the prior art. The flexible nature of the separator overcome separator brittleness and improve handleability.

The composite solid-state electrolyte separator can be used in conventional lithium-ion batteries. The solid-state electrolyte separator is amendable to lithium-ion battery production processes.

One advantage of the composite solid-state separator is in-situ separator casting onto a battery electrode. Another advantage of the composite solid-state separator is its adhesive nature. The solid-state electrolyte can adhesively bond the separator to the anode and cathode of battery. The adhesive bond enhances the interfacial properties of each of the separator, anode and cathode.

The ceramic solid-state electrolyte generally can have high temperature resiliency, high ionic conductivity, and resiliency to oxygen and ambient air.

In some embodiments, the polymeric matrix can be selected from the group consisting of polyethylene oxide, poly(propylene oxide), poly[bis(methoxyethoxyethox-ide)-phosphazene], poly(dimethylsiloxane), polyacrylonitrile, poly(methyl methacrylate), poly(vinyl chloride), poly(vinylidene fluoride), poly(vinylidene fluoride-co-hexafluoropropylene), and mixtures thereof.

In some embodiments, the polymeric matrix can be a porous substrate. The porous substrate can be a microporous or microporous matrix. The porous substrate can comprise a fabric or a film. In some embodiments, the porous matrix can be selected from the group consisting of polyolefins, polyethylenes, polypropylenes, poly tetrafluoroethylenes, polyvinyl chlorides, and mixtures thereof. The porous substrate can have s coating layer. The coating layer can comprise one of: one or more of the ion conducting layers, one or more solid-state electrolyte layers, or combination of one or ion conducing and one or more solid-state electrolyte layers. The one or more ion conducting layers can comprise the same ion conducting material or different ion conducting materials. The one or more solid-state electrolyte materials can comprise the same solid-state electrolyte material or different solid-state electrolyte materials.

In some embodiments, the porous substrate can comprise a textile fabric. The textile fabric can be selected from the group consisting of woven fabrics, nonwoven fabrics and knitted fabrics. The textile fabric can comprise one of cotton, nylon, polyester, glass, rubber, asbestos, wood, a polyolefin, polyethylene, polypropylene, vinylon, fibrillated cellulose nanofiber, and mixtures thereof. The textile fabric can comprise microfiber nonwoven fabric. The textile fabric can comprise a microfiber woven fabric.

The cathode functional coating can comprise M_{z}TX_{y}, where M is an alkali metal, T is one of Al or W, and X is one of oxygen or fluorine. Generally, z can have a value from about 0.5 to about 10 and y can have a value from about 1.75 to about 6.5. More generally, z can have a value from about 1 to about 5 and y can have a value from about 2 to about 4.

### The Electrolyte

In some embodiments, the electrolyte is a solid-state electrolyte. In some embodiments, the solid-state electrolyte comprises a ceramic material. In some embodiments, the ceramic material is a solid-state electrolyte.

The solid-state electrolyte generally comprises an ionic conducting solid electrolyte. The solid-state electrolyte can be selected from the group consisting of a polymeric electrolyte, a solid-state electrolyte, and mixtures thereof.

The ionic conducting solid-state electrolyte can be a lithium ion conducting solid electrolyte. In some embodiments, the lithium ion conducting solid electrolyte can be selected from the group consisting of a polymeric electrolyte, a solid-state electrolyte, and mixtures thereof.

The ionic conducting electrolyte can be selected from the group consisting of a non-aqueous electrolyte, an aprotic liquid electrolyte, a room temperature ionic liquid electrolyte, a polymeric electrolyte, a polymeric gel electrolyte, a solid-state electrolyte, or a mixture thereof.

The ionic conducting electrolyte can be a lithium ion conducting electrolyte. In some embodiments, the lithium ion electrolyte can be selected from the group consisting of a non-aqueous electrolyte, an aprotic liquid electrolyte, a room temperature ionic liquid electrolyte, a polymeric electrolyte, a polymeric gel electrolyte, a solid-state electrolyte, or a mixture thereof. The non-aqueous electrolyte and/or aprotic liquid electrolyte can comprise an electrolytic salt dissolved in an organic. The non-aqueous electrolyte and/or an aprotic liquid electrolyte comprise a lithium ion electrolytic salt dissolved in an organic solvent.

The polymeric electrolyte can be an electrolyte salt incorporated in a polymeric material. In some embodiments, the electrolyte salt can be incorporated in the polymeric backbone of the polymeric material. The electrolytic salt can be a lithium ion salt. In some embodiments, the lithium ion salt can be selected from the group consisting of lithium hexafluorophosphate, lithium hexafluoroarsenate, lithium perchlorate, lithium tetrafluoroborate, lithium trifluoromethane sulfonate, lithium bis(fluorosulfonyl)imide, lithium bis(trifluoromethanesulfonyl)imide, lithium bis(pentafluoroethylsulfonyl)imide, lithium tris(trifluoromethylsulfonyl)methide, lithium trifluoro tris(pentafluoroethyl)phosphate, lithium bis(oxalato)borate, lithium hexafluoroisopropoxide, lithium malonate borate, lithium difluoro(oxalato) borate, lithium hexafluoroantimonate, and mixtures thereof. In some embodiments, the polymeric electrolyte can be selected from the group consisting of polyethylene oxide, polyacrylonitrile, polymethyl methacrylate, polyvinylidene fluoride, polyvinylidene fluoride, hexafluoropropylene, and mixtures thereof.

The solid-state electrolyte can be selected from the group consisting of a metal oxide, a metal fluoride, a Garnet ion conductor, a sodium super ionic conductor, a lithium super ionic conductor, a sulfide having a lithium super ionic conductor structure, and a lithium phosphorous nitrogen ion conductor, or a mixture thereof.

In some embodiments, the metal oxide comprises an alkali metal oxide. In some embodiments, the alkali metal oxide comprises lithium niobium oxide, LiₓNbO_{y}, where x can have a value from about 1 to about 5 and y can have a value from about 3 to 5.

The Garnet solid electrolyte can be selected from the group consisting of Li₅La₃Ta₂O₁₂, Li₇La₃Zr₂O₁₂, Li₃Ln₃Te₂O₁₂ where Ln comprises a lanthanide or a mixture of lanthanides.

The lithium super ionic conductor can be selected from the group consisting of Li_{3.5}Zn_{0.25}GeO₄, Li_{3.4}Si_{0.4}V_{0.6}O₄, Li₂ZnGeO₄, Li₂₊₂ₓZn₁₋ₓGeO₄ where x can have a value from about −0.36 to about 0.87, and mixtures thereof.

The sulfide having a lithium super ionic conductor structure can be selected from the group consisting of Li_{3.25}Ge_{0.25}P_{0.75}S₄, Li₁₀GeP₂S₁₂, Li₄₋ₓM_{1-y}M′_{y}S₄ and mixtures thereof. M can be one of Si, Ge, or a mixture thereof. M′ can be selected from the group consisting of P, Al, Zn, Ga, and mixtures thereof.

The metal oxide or a metal fluoride can be selected from the group consisting of an alkali metal aluminum oxide, an alkali metal fluoride, an alkali metal sulfide, an alkaline earth metal oxide, an alkaline earth fluoride, and mixtures thereof.

In some embodiments, the alkali metal aluminum oxide can be M_{z}AlX_{y}, where M is one of alkali metal, X is one of oxygen or fluorine and z can have a value from about 0.5 to about 10 and y can have a value from about 1.75 to about 6.5. In some embodiments, z can have a value from about 1 to about 5 and y can have a value from about 2 to about 4. The alkali metal aluminum oxide solid electrolyte can comprise LiAlOₓ having a Li:Al molar ratio selected from the group consisting of: 1:1, 1.5:1, 2:1, 2.5:1, 3:1, 3.5:1, 4:1, 4.5:1 and 5:1.

In some embodiments, the ion conducting solid electrolyte can be selected from the group consisting of alumina (Al₂O₃), silica (SiO₂), titania (TiO₂), zirconia (ZrO₂), and mixtures thereof.

In some embodiments, the electrolyte can be mixed with a solvent. Generally, the solvent is an organic solvent. In some embodiments, the organic solvent is selected from the group consisting of nitriles, carbonates, borates, esters, ethers, sulfones, sulfides, acetals, phosghites, phosphates, or a mixture thereof. The nitrile can be selected from the group consisting of acetonitrile, butyronitrile, valeronitrile, hexanenitrile, 3-methoxypropionitrile, and mixtures thereof. The carbonate can be selected from the group consisting of ethylene carbonate, propylene carbonate, dimethyl carbonate, diethyl carbonate, ethyl methyl carbonate, fluorinated carbonates, methyl trifluoroethyl carbonate, and mixtures thereof. The ester can be selected from the group consisting of γ-butyrolactone, ethyl acetate, ethyl propionate, methyl propionate, methyl butyrate, ethyl butyrate, propyl butyrate, butyl butyrate, and mixtures thereof. The ether can be selected from the group consisting of diglyme, hydrofluoroether, and mixtures thereof. The acetal can be 1,3-dioxolane. The sulfone solvent can be selected from the group consisting of ethylmethyl sulfone, 2,2,2-trifluoroethylmethyl sulfone, ethyl-sec-butyl sulfone, and mixtures thereof. In some embodiments, the organic carbonate solvent can comprise one or more of vinylene carbonate, fluoroethylene carbonate, lithium difluoro(oxalato)borate, butyl sulfide, tris hexafluoroisopropyl phosphate, tris(trimethylsilyl) phosphite, and lithium nitrate.

In some embodiments, the organic carbonate solvent can be mixed with used as an additive. The additive can be selected from the group consisting of vinylene carbonate, fluoroethylene carbonate, lithium difluoro(oxalato)borate, butyl sulfide, tris hexafluoroisopropyl phosphate, tris(trimethylsilyl) phosphite, and mixtures thereof.

The ion conducting electrolyte can comprise one of more of the following polymers: polyimide, poly(fluorene), polyphenylenes, polypyrenes, polyazulene, polynaphthalenes, poly(acetylene), poly(p-phenylene vinylene), poly(pyrrole), polycarbazole, polyindole, polyazepine, polyaniline, poly(thiophene), poly(3,4-ethylenedioxythiophene), poly(p-phenylene sulfide), and poly(3,4-ethylenedioxythiophene). The metal fluoride can be selected from the group consisting of an alkali metal fluoride, an alkaline earth fluoride and mixtures thereof.

The room temperature ionic liquid electrolyte can comprise an electrolytic salt dissolved in a room temperature ionic liquid. The room temperature ionic liquid can comprise a cation selected from the group consisting of imidazolium, pyridinium, pyrrolidinium, phosphonium, ammonium, and anions including BF₄⁻, PF₆⁻, CF₃SO₃⁻, N(CF₃SO₂)₂⁻, (C₄F₉)₃PF₃⁻, N-Ethyl-N,N-dimethyl-2-methoxyethyl ammonium, 1-butyl-1methyl-pyrrolidinium, 1-Ethyl-3-methylimidazolium, 1-methyl-3-propylpyrrolidinium and a mixture thereof. In some embodiments, the room temperature ionic liquid can comprises an anion selected from the group consisting of tris(pentafluoroethyl)trifluorophosphate), bis(trifluoro methyl sulfonyl) imide), bis(fluorosulfonyl)imide and a mixture thereof.

In some embodiments, a polymeric electrolyte comprises a polymer selected from the group consisting of polyethylene oxide, polyacrylonitrile, polymethyl methacrylate, polyvinylidene fluoride, polyvinylidene fluoride, hexafluoropropylene, or a mixture thereof. The polymeric electrolyte comprises an electrolytic salt incorporated in polymeric material. In some embodiments, the polymeric electrolyte comprises an electrolytic salt incorporated into the polymeric backbone of the polymeric material

### The Cathode

The cathode can comprise a cathode current collector and one or more cathode active materials. The one or more cathode active materials are generally applied to one or more surfaces of the cathode current collector. Some embodiments can include cathodes having one or more cathode functional materials. The one or more cathode functional materials can be applied as coating on and/or mixed with one or more cathode active materials. In some embodiments, the one or more cathode functional materials can be applied to one or more surfaces of cathode current collector prior the application of the one or more cathode active materials. In some embodiments, the one or more cathode functional materials can be applied to the one or more cathode active materials after their application to the one or more surfaces of the cathode current collector.

In accordance with some embodiments, the cathode comprises one or more cathode active materials, a polymeric binder, a conductive carbon, a polymer electrolyte, an ion conducting solid electrolyte, and a current collector. The one or more cathode active materials can store energy electrochemically. Generally, the one or more cathode active materials store energy electrochemically by Faradaic redox reactions. The ion conducting solid electrolyte can a ceramic. The conductive carbon can be selected from the group consisting of carbon black, conductive graphite, carbon nanotube, graphene, and a mixture thereof. The carbon black can be selected from the group consisting of carcass grade carbon black, furnace grade carbon black, hard carbon black, soft carbon black, thermal carbon black, acetylenic thermal carbon black, channel black, lamp black, carbon nanotube, graphene, and a mixture thereof. The conductive graphite can be selected from the group consisting of natural graphite, crystalline flack graphite, amorphous graphite, pyrolytic graphite, graphene, lump graphite, and graphite fiber, and a mixture thereof. The polymeric binder can be selected from the group consisting of poly(tetrafluoroethylene), poly(vinylidenefluoride) homopolymer, poly(vinylidenefluoride) co-polymer, styrene-butadiene rubber/carboxymethylcellulose aqueous copolymers, lithium poly(acrylic acid) aqueous polymer, a polymer electrolyte, and a mixture thereof.

In accordance with some embodiments, the cathode can have from about 60% to about 98 wt % of the cathode active material, from about 1% to about 10 wt % of the conductive carbon, and from about 1% to about 10 wt % of the polymeric binder, and from about 1% to about 20 wt % of the polymer electrolyte, and from about 1% to about 20 wt % of the ion conducting solid electrolyte and/or ceramic.

### The Cathode Active Materials

When one of the cathode active materials is an intercalation material, the cathode active material can be selected from the group consisting of graphite, soft carbon, hard carbon, graphene, graphene oxide, carbon nanotube, and mixtures thereof.

When one of cathode active materials is a conversion material, the cathode active material can selected from the group that shows the following conversion reaction: MₐX_{b}+(b·n) Li↔aM+bLiₙX, where M=transition metal, X=anion (e.g., O, N, F, S, P), and n=formal oxidation state of X, or a mixture thereof.

When one of cathode active materials is a conversion material, the cathode active material can be selected from the group consisting of metal oxides, lithium-containing nitrides, phosphides, arsenides, antimonides, bismides, hydrides, metallic alloys, and mixtures thereof. The cathode active material can be selected from the group of metal oxides consisting of Fe₂O₃, CoO, Co₃O₄, TiO₂, Cu₂O, SnO, MnO, NiO, TiP₂O₇, and mixtures thereof. The cathode active material can be selected from the group of lithium-containing nitrides consisting of Li₃₋ₓCoₓN, where x can have a value from about 0.2 to about 0.6, Li₃N, and mixtures thereof. The cathode active material can be selected from the group of phosphides consisting of Sn₄P₃, LiₓVP₄, where x is from about 3 to about 7.5. LiₓTiP₄, where x is from about 2 to about 11. TiP₂, MnP, FeP_{x=1, 2, 4}, Cu₃P, Ni₅P₄, and mixtures thereof. The cathode active material can be selected from the group of arsenides consisting of LiₓVAs₄, where x is from about 2 to about 10. LiₓTiAs₄, where x is from about 2 to about 10. FeAs, and mixtures thereof. The cathode active material can be selected from the group of antimonides consisting of CoSb₃, TiSnSb, and mixtures thereof. The cathode active material can be selected from the group of hydrides consisting of MgH₂, TiH₂, Mg₂FeH₆, Mg₂CoH₅, Mg₂NiH₄, and mixtures thereof. The cathode active material can be selected from the group of metallic alloys consisting of two or more of Si, Ge, Sn, Pb, P, As, Sb, Bi, Al, Ga, Zn, Ag, Mg, In, Cd, and Au.

### The Cathode Active Materials

The one or more cathode active materials can store energy electrochemically. Generally, the one or more cathode active materials store energy electrochemically by Faradaic oxidation-reduction reactions. One or more of cathode active materials can be intercalation, alloying and conversion materials.

The one or more cathode active materials can be selected from the group consisting of lithium transition metal oxides, lithium transition metal nitrides, lithium transition metal sulfides, lithium transition metal phosphates, lithium metal silicates, lithium tavorites, lithium transition metal pyrophosphates, elemental sulfur, lithium sulfide, carbon monofluoride, and mixtures thereof.

In some embodiments, the lithium transition metal oxide comprises a layered lithium transition metal oxide. The layered lithium transition metal oxide can be selected from the group consisting of LiCoO₂, LiNiO₂, LiMnO₂, Li_{1+δ}(NiₓCo_{y}Mn_{z})_{1-δ}O₂ (0.1≥δ≥0, 1≥(x, y, z)≥0, x+y+z=1), Li_{1+δ}(Ni_{0.8}Co_{0.2-x}Alₓ)_{1-δ}O₂ (0.1≥δ≥0, 0.1≥x≥0), and mixtures thereof.

In some embodiments, the lithium transition metal oxide can have spinel structure. The spinel structure can be a high voltage spinel structure. The lithium transition-metal oxide having a spinel structure can selected from the group consisting of Li_{1+δ}(Mn₂₋ₓM′ₓ)_{1-δ}O₄ (M′=Co, Ni, 0.1≥x≥0, 0.1≥δ≥0), Li_{w}NiₓMn_{y}O_{z} (0.8<w<1.2, 0.3<x<0.8, 1.3<y<1.8, 3.8<z<4.2), and mixtures thereof.

In some embodiments, the lithium metal oxide can comprise a lithium and manganese rich layered structure. The lithium metal oxide having a lithium and manganese rich layered structure can comprise xLi₂MnO₃.(1−x)LiNi_{y}Mn_{z}Co_{(1-y-z)}O₂ (0<x<1, 0≤y≤1, 0<z<1, y+z≤1), xLi₂MnO₃.(1−x)LiMnO₂ (0<x<1), xLi₂MnO₃.(1−x)LiNiO₂ (0<x<1), xLi₂MnO₃.(1−x)LiCoO₂ (0<x<1), xLi₂MnO₃.(1−x)LiCrO₂ (0<x<1), and mixtures thereof.

In some embodiments, the lithium metal oxide can comprise a lithium and manganese rich layered material having a spinel structure. The lithium metal oxide having a lithium and manganese rich layered material having a spinel structure can comprise xLi₂MnO₃.(1−x)LiMn₂O₄ (0<x<1), xLi₂MnO₃.(1−x)LiNi₂O₄ (0<x<1), xLi₂MnO₃.(1−x)LiCo₂O₄ (0<x<1), xLi₂MnO₃.(1−x)LiCr₂O₄ (0<x<1), and mixtures thereof.

In some embodiments, the transition metal oxide can be selected from the group consisting of V₂O₅, MoO₃, and mixtures thereof.

In some embodiments, the transition metal sulfide can be TiS₂.

In some embodiments, the transition metal sulfide can be FeF₃.

In some embodiments, lithium transition metal phosphate can be an olivine-type phosphate. The olivine-type phosphate can be selected from the group consisting of LiFePO₄, LiFeMnO₄, LiCoPO₄, LiNiPO₄, or mixtures thereof.

The lithium silicate can be selected from the group consisting of Li₂FeSiO₄, Li₂MnSiO₄, Li₂CoSiO₄, and mixtures thereof.

The lithium tavorite can be selected from the group consisting of Li₂Fe(PO₄)O, Li₂Mn(PO₄)O, Li₂Ni(PO₄)O, Li₂Co(PO₄)O, Li₂V(PO₄)O, Li₂Mo(PO₄)O, Li₂W(PO₄)O, Li₂Nb(PO₄)O, Li₂Fe(PO₄)OH, Li₂Mn(PO₄)OH, Li₂Ni(PO₄)OH, Li₂Co(PO₄)OH, Li₂V(PO₄)OH, Li₂Mo(PO₄)OH, Li₂W(PO₄)OH, Li₂Nb(PO₄)OH, Li₂Fe(PO₄)F, Li₂Mn(PO₄)F, Li₂Ni(PO₄)F, Li₂Co(PO₄)F, Li₂V(PO₄)F, Li₂Mo(PO₄)F, Li₂W(PO₄)F, Li₂Nb(PO₄)F, Li₂Fe(SO₄)O, Li₂Mn(SO₄)O, Li₂Ni(SO₄)O, Li₂Co(SO₄)O, Li₂V(SO₄)O, Li₂Mo(SO₄)O, Li₂W(SO₄)O, Li₂Nb(SO₄)O, Li₂Fe(SO₄)OH, Li₂Mn(SO₄)OH, Li₂Ni(SO₄)OH, Li₂Co(SO₄)OH, Li₂V(SO₄)OH, Li₂Mo(SO₄)OH, Li₂W(SO₄)OH, Li₂Nb(SO₄)OH, Li₂Fe(SO₄)F, Li₂Mn(SO₄)F, Li₂Ni(SO₄)F, Li₂Co(SO₄)F, Li₂V(SO₄)F, Li₂Mo(SO₄)F, Li₂W(SO₄)F, Li₂Nb(SO₄)F, and mixtures thereof.

The lithium transition metal pyrophosphate can be selected from the group consisting of Li₂FeP₂O₇, Li₂MnP₂O₇, Li₂NiP₂O₇, Li₂CoP₂O₇, and mixtures thereof.

In some embodiments, the cathode active material comprises elemental sulfur (S⁰).

In some embodiments, the cathode active material comprises lithium sulfide (Li₂S).

The carbon monofluoride (CFₓ) can be selected from the group consisting of carbon monofluoride having a value of x from about 1.01 to about 1.20, a value of x from about 1.05 to about 1.11; and a value of x of about 1.08.

### Cathode Functional Coatings

The cathode functional coating can be one or more protect and stabilize an electrochemical energy storage device. Moreover, the cathode functional coating can one or more of enhance electrochemical performance and strengthen stabilities. The protection, stabilization and enhanced electrochemical performance and strengthen stabilities can increase long-term cycle life and storage life of the electrochemical energy storage device. The cathode functional coating can be selected from the group consisting of metal oxides, metal nitrides, metal sulfides, metal phosphates, polymers, ion conducting electrolytes, solid electrolytes, a metal fluoride, a Garnet ion conductor, a sodium super ionic conductor, a lithium super ionic conductor, a sulfide having a lithium super ionic conductor structure, a lithium phosphorous nitrogen ion conductor, an alkali metal sulfide, an alkali metal oxide, an alkali metal aluminum oxide, an alkaline earth metal aluminum oxide, an alkali metal fluoride, an alkaline earth aluminum fluoride and mixtures thereof. The metal oxides can be selected from group consisting of an alkali metal aluminum oxide, an alkaline earth metal oxide, Al₂O₃, BaTiO₃, BaSrTiO₃, Bi₂O₃, Co₂O₃, FeOx, Fe₃O₄, Ga₂O₃, HfO₂, In₂O₃, IrO₂, MnO₂, MoO₂, NiO, Ni(OH)₂, RuO₂, SiO₂, SnO₂, TiO₂, V₂O₅, Yb₂O₃, ZnO, ZrO₂, and mixtures thereof. The metal nitride can be selected from the group consisting of TiN, TaN, HfN, Hf₃N₄, Zr₃N₄, ZrNₓ, NbN, and mixtures thereof. The metal sulfide can be selected from the group consisting of PbS, ZnS, CaS, BaS, SrS, CURS, CdS, In₂S₃, WS₂, TiS₂, Sb₂S₃, SnS, GaSₓ, GeS, MoS₂, Li₂S, and mixtures thereof. The metal phosphate can be selected from the group consisting of AlPO₄, TiPO₄, FeAlPO₄, SiAlPO₄, CoAlPO₄MnAlPO₄, Li₃PO₄, NaH₂PO₄, and mixtures thereof. In some embodiments, the alkali metal aluminum oxide and/or fluoride and/or alkaline earth metal oxide and/or fluoride can be M_{z}AlX_{y}, where M is one of alkali metal or alkaline earth metal, X is one of oxygen or fluorine and z can have a value from about 0.5 to about 10 and y can have a value from about 1.75 to about 6.5. In some embodiments, z can have a value from about 1 to about 5 and y can have a value from about 2 to about 4. The alkali metal aluminum oxide solid electrolyte can comprise LiAlOₓ having a Li:Al molar ratio selected from the group consisting of: 1:1, 1.5:1, 2:1, 2.5:1, 3:1, 3.5:1, 4:1, 4.5:1 and 5:1. In some embodiments, the metal oxide comprises an alkali metal oxide. In some embodiments, the alkali metal oxide comprises lithium niobium oxide, LiₓNbO_{y}, where x can have a value from about 1 to about 5 and y can have a value from about 3 to 5. The Garnet solid electrolyte can be selected from the group consisting of Li₅La₃Ta₂O₁₂, Li₇La₃Zr₂O₁₂, Li₃Ln₃Te₂O₁₂ where Ln comprises a lanthanide or a mixture of lanthanides. The lithium super ionic conductor can be selected from the group consisting of Li_{3.5}Zn_{0.25}GeO₄, Li_{3.4}Si_{0.4}V_{0.6}O₄, Li₂ZnGeO₄, Li₂₊₂ₓZn₁₋ₓGeO₄ where x can have a value from about −0.36 to about 0.87, and mixtures thereof. The sulfide having a lithium super ionic conductor structure can be selected from the group consisting of Li_{3.25}Ge_{0.25}P_{0.75}S₄, Li₁₀GeP₂S₁₂, Li₄₋ₓM_{1-y}M′_{y}S₄ and mixtures thereof. M can be one of Si, Ge, or a mixture thereof. M′ can be selected from the group consisting of P, Al, Zn, Ga, and mixtures thereof.

The ion conducting electrolyte can comprise one of more of the following polymers: polyimide, poly(fluorene), polyphenylenes, polypyrenes, polyazulene, polynaphthalenes, poly(acetylene), poly(p-phenylene vinylene), poly(pyrrole), polycarbazole, polyindole, polyazepine, polyaniline, poly(thiophene), poly(3,4-ethylenedioxythiophene), poly(p-phenylene sulfide), and poly(3,4-ethylenedioxythiophene). The metal fluoride can be selected from the group consisting of an alkali metal fluoride, an alkaline earth fluoride and mixtures thereof.

The cathode functional coating can comprise M_{z}TX_{y}, where M is an alkali metal, T is one of Al or W, and X is one of oxygen or fluorine. Generally, z can have a value from about 0.5 to about 10 and y can have a value from about 1.75 to about 6.5. More generally, z can have a value from about 1 to about 5 and y can have a value from about 2 to about 4.

### Cathode Current Collector

The cathode current can comprise one of aluminum, nickel, titanium, stainless steel, carbon coated aluminum, carbon coated nickel, carbon coated titanium, or carbon coated stainless steel.

### The Anode

The anode can comprise an anode current collector and one or more anode active materials. The one or more anode active materials are generally applied to one or more surfaces of the anode current collector. Some embodiments can include anodes having one or more functional materials. The one or more anode functional materials can be applied as coating on and/or mixed with one or more anode active materials. In some embodiments, the one or more anode functional materials can be applied to one or more surfaces of the anode current collector prior the application of the one or more anode active materials. In some embodiments, the one or more anode functional materials can be applied to the one or more anode active materials after their application to the one or more surfaces of the anode current collector.

In accordance with some embodiments, the anode electrode contains one or more anode active materials, a polymeric binder, a conductive carbon, a polymer electrolyte, an ion conducting solid electrolyte, and a current collector. The one or more anode active materials can store energy electrostatically, electrochemically or both. Generally, the one or more abode active materials store energy electrochemically by Faradaic redox reactions. The ion conducting solid electrolyte can a ceramic. The conductive carbon can be selected from the group consisting of carbon black, conductive graphite, carbon nanotube, graphene, and a mixture thereof. The carbon black can be selected from the group consisting of carcass grade carbon black, furnace grade carbon black, hard carbon black, soft carbon black, thermal carbon black, acetylenic thermal carbon black, channel black, lamp black, carbon nanotube, graphene, and a mixture thereof. The conductive graphite can be selected from the group consisting of natural graphite, crystalline flack graphite, petroleum coke, amorphous graphite, pyrolytic graphite, graphene, lump graphite, and graphite fiber, and a mixture thereof. The polymeric binder can be selected from the group consisting of poly(tetrafluoroethylene), poly(vinylidenefluoride) homopolymer, poly(vinylidenefluoride) co-polymer, styrene-butadiene rubber/carboxymethylcellulose aqueous copolymers, lithium poly(acrylic acid) aqueous polymer, a polymer electrolyte, and a mixture thereof.

In accordance with some embodiments, the anode can have from about 60% to about 98 wt % of the anode active material, from about 1% to about 10 wt % of the conductive carbon, and from about 1% to about 10 wt % of the polymeric binder, and from about 1% to about 20 wt % of the polymer electrolyte, and from about 1% to about 20 wt % of the ion conducting solid electrolyte. In some embodiments, the solid electrolyte can comprise a ceramic.

In some embodiments, the anode electrode can comprise one or more of lithium metal, sodium metal, and magnesium metal.

### The Anode Active Materials

The one or more anode active materials can store energy electrochemically. Generally, the one or more anode active materials store energy electrochemically by Faradaic redox reactions.

The one or more anode active materials can be selected from the group consisting of carbonaceous materials, metal oxides, lithium titanate spinel Li₄Ti₅O₁₂, group IV elements silicon, germanium, tin, lithium metal, sodium metal, magnesium metal, and mixtures thereof. The silicon anode active materials can be selected from the group consisting of SiO, SiO₂, metal alloys containing silicon, and mixtures thereof. The tin anode active materials can be selected from the group consisting of SnO, SnO₂, metal alloys containing tin, and mixtures thereof. The germanium anode active materials can be selected from the group consisting of GeO, GeO₂, metal alloys of germanium, and mixtures thereof. The metal oxides can be selected from the group consisting of Fe₂O₃, CoO, Co₃O₄, TiO₂, Cu₂O, MnO, and mixtures thereof.

The carbonaceous material can be selected from the group consisting of graphite, soft carbon, hard carbon, graphene, graphene oxide, carbon nanotube, and mixtures thereof. The graphite can be selected from the group consisting of natural graphite, crystalline flack graphite, amorphous graphite, pyrolytic graphite, graphene, lump graphite, and graphite fiber, mesocarbon microbeads, and mixtures thereof. The soft carbon is generally made from organic precursors that melt before they pyrolyze (graphitizable). More generally, the soft carbon has neatly stacked graphene layers and with less long-range order. The hard carbon typically comprises graphene layers that are not neatly stacked, are generally non-crystalline and are usually macroscopically isotropic. In some embodiments, the hard carbon used as the anode active material is made from organic precursors that char as they pyrolyze (non-graphitizable). The hard carbon generally has graphene layers that are not neatly stacked, non-crystalline and macroscopically isotropic.

The one or more anode active materials can be ionically pre-doped. In some embodiments, the one or more anode active materials can be pre-doped with lithium. In some embodiments, the one or more anode active materials can be pre-lithiated. The one or more anode active materials can be pre-lithiated chemically, electrochemically or a combination of chemically and electrochemically. Generally, the pre-lithiation can be an in-situ or an ex-situ method. Moreover, one or more anode active material is pre-lithiation process can utilize one or more of lithium metal and stabilized lithium metal powder.

The one or more anode active materials can store energy electrochemically. Generally, the one or more anode active materials store energy electrochemically by Faradaic oxidation-reduction reactions. The one or more anode materials can be selected from the group consisting of lithium metal, sodium metal, magnesium metal, and mixtures thereof.

### Anode Functional Coatings

The anode functional coating can be one or more protect and stabilize an electrochemical energy storage device. Moreover, the anode functional coating can one or more of enhance electrochemical performance and strengthen stabilities. The protection, stabilization and enhanced electrochemical performance and strengthen stabilities can increase long-term cycle life and storage life of the electrochemical energy storage device. The anode functional coating can be selected from the group consisting of metal oxides, metal nitrides, metal sulfides, metal phosphates, polymers, ion conducting electrolytes, solid electrolytes, a metal fluoride, a Garnet ion conductor, a sodium super ionic conductor, a lithium super ionic conductor, a sulfide having a lithium super ionic conductor structure, a lithium phosphorous nitrogen ion conductor, an alkali metal sulfide, an alkali metal oxide, an alkali metal aluminum oxide, an alkaline earth metal aluminum oxide, an alkali metal fluoride, an alkaline earth aluminum fluoride and mixtures thereof. The metal oxides can be selected from group consisting of an alkali metal aluminum oxide, an alkaline earth metal oxide, Al₂O₃, BaTiO₃, BaSrTiO₃, Bi₂O₃, Co₂O₃, FeOₓ, Fe₃O₄, Ga₂O₃, HfO₂, In₂O₃, IrO₂, MnO₂, MoO₂, NiO, Ni(OH)₂, RuO₂, SiO₂, SnO₂, TiO₂, V₂O₅, Yb₂O₃, ZnO, ZrO₂, and mixtures thereof. The metal nitride can be selected from the group consisting of TiN, TaN, HfN, Hf₃N₄, Zr₃N₄, ZrNₓ, NbN, and mixtures thereof. The metal sulfide can be selected from the group consisting of PbS, ZnS, CaS, BaS, SrS, CURS, CdS, In₂S₃, WS₂, TiS₂, Sb₂S₃, SnS, GaSₓ, GeS, MoS₂, Li₂S, and mixtures thereof. The metal phosphate can be selected from the group consisting of AlPO₄, TiPO₄, FeAlPO₄, SiAlPO₄, CoAlPO₄MnAlPO₄, Li₃PO₄, NaH₂PO₄, and mixtures thereof. In some embodiments, the alkali metal aluminum oxide and/or fluoride and/or alkaline earth metal oxide and/or fluoride can be M_{z}AlX_{y}, where M is one of alkali metal and alkaline earth metal, X is one of oxygen or fluorine and z can have a value from about 0.5 to about 10 and y can have a value from about 1.75 to about 6.5. In some embodiments, z can have a value from about 1 to about 5 and y can have a value from about 2 to about 4. The alkali metal aluminum oxide solid electrolyte can comprise LiAlOₓ having a Li:Al molar ratio selected from the group consisting of: 1:1, 1.5:1, 2:1, 2.5:1, 3:1, 3.5:1, 4:1, 4.5:1 and 5:1. In some embodiments, the metal oxide comprises an alkali metal oxide. In some embodiments, the alkali metal oxide comprises lithium niobium oxide, LiₓNbO_{y}, where x can have a value from about 1 to about 5 and y can have a value from about 3 to 5. The Garnet solid electrolyte can be selected from the group consisting of Li₅La₃Ta₂O₁₂, Li₇La₃Zr₂O₁₂, Li₃Ln₃Te₂O₁₂ where Ln comprises a lanthanide or a mixture of lanthanides. The lithium super ionic conductor can be selected from the group consisting of Li_{3.5}Zn_{0.25}GeO₄, Li_{3.4}Si_{0.4}V_{0.6}O₄, Li₂ZnGeO₄, Li₂₊₂ₓZn₁₋ₓGeO₄ where x can have a value from about −0.36 to about 0.87, and mixtures thereof. The sulfide having a lithium super ionic conductor structure can be selected from the group consisting of Li_{3.25}Ge_{0.25}P_{0.75}S₄, Li₁₀GeP₂S₁₂, Li₄₋ₓM_{1-y}M′_{y}S₄ and mixtures thereof. M can be one of Si, Ge, or a mixture thereof. M′ can be selected from the group consisting of P, Al, Zn, Ga, and mixtures thereof.

The ion conducting electrolyte can comprise one of more of the following polymers: polyimide, poly(fluorene), polyphenylenes, polypyrenes, polyazulene, polynaphthalenes, poly(acetylene), poly(p-phenylene vinylene), poly(pyrrole), polycarbazole, polyindole, polyazepine, polyaniline, poly(thiophene), poly(3,4-ethylenedioxythiophene), poly(p-phenylene sulfide), and poly(3,4-ethylenedioxythiophene). The metal fluoride can be selected from the group consisting of an alkali metal fluoride, an alkaline earth fluoride and mixtures thereof.

The anode functional coating can comprise M_{z}Tx_{y}, where M is an alkali metal, T is one of Al or W, and X is one of oxygen or fluorine. Generally, z can have a value from about 0.5 to about 10 and y can have a value from about 1.75 to about 6.5. More generally, z can have a value from about 1 to about 5 and y can have a value from about 2 to about 4.

### Anode Current Collector

The anode current can comprise one of copper, nickel, titanium, stainless steel, carbon coated copper, carbon coated nickel, carbon coated titanium, or carbon coated stainless steel. In some embodiments, the anode current can comprise one of copper, nickel, titanium, stainless steel, carbon coated copper, carbon coated nickel, carbon coated titanium, or carbon coated stainless steel.

### Method of Making Anodes and Cathodes

The method of making a cathode can include mixing one more cathode active materials one or more of mechanically, chemically, electrochemically. In some embodiments, the one or more cathode active materials are mixed at one or more of atomic and molecular levels. In accordance with some embodiments, the one or more cathodes active materials are mixed and chemically bonded together. The one or more cathode active materials can be mixed conformally via chemical vapor deposition, physical vapor deposition, chemical deposition, electrochemical deposition, spraying deposition, spin coating deposition, molecular layer deposition, atomic layer deposition, and combinations thereof. In some embodiments, the one or more cathode materials are mixed at the atomic level by an atomic layer deposition process.

The method of making an anode can include mixing one more anode active materials one or more of mechanically, chemically, electrochemically. In some embodiments, the one or more anode active materials are mixed at one or more of atomic and molecular levels. In accordance with some embodiments, the one or more anodes active materials are mixed and chemically bonded together. The one or more anode active materials can be mixed conformally via chemical vapor deposition, physical vapor deposition, chemical deposition, electrochemical deposition, spraying deposition, spin coating deposition, molecular layer deposition, atomic layer deposition, and combinations thereof. In some embodiments, the one or more anode materials are mixed at the atomic level by an atomic layer deposition process.

### Battery

Some embodiments include a battery having one of aluminum laminated film pouch, or a metal case. In some embodiments, the metal case for the all-solid-state battery is made of metals from a selected group consisting of aluminum, nickel, titanium, and stainless steel. The enclosure can comprise one of aluminum laminated film pouch or a metal case. In some embodiments, the metal case can comprise one of aluminum, nickel, titanium, and stainless steel.

Some embodiments include a battery comprising:

a first electrode;

a second electrode;

a separator positioned between the first and second electrodes; and

an enclosure having a void volume, the void volume being occupied by the separator and the first and second electrodes.

The first electrode is typically an anode. More typically, the first electrode comprises a lithium anode. In some embodiments, the first electrode can comprise one or more anode active materials. Furthermore, the first electrode can comprise in some embodiments one or more anode active materials and one or more functional coatings.

The second electrode is generally a cathode. More generally, the second electrode comprises a tin cathode. Even more generally, the second electrode comprises one or more of Sn, Li₂Sn₅, LiSn, Li₇Sn₃, Li₅Sn₂, Li₁₃Sn₅, Li₇Sn₂, and Li₂₂Sn₅. The second electrode can comprise one or more cathode active materials. Moreover, in some embodiments the second electrode can comprise one or more cathode active materials and one or more functional coatings.

The enclosure can comprise one of a button cell enclosure and/or a coin cell enclosure format.

In accordance with some embodiments of the present disclosure is a device comprising the nanocomposite separator and/or membrane described herein. The device can be an electrochemical energy storage device. In some embodiments, the electrochemical device can be a battery. In some embodiments, the electrochemical device can be a supercapacitor. The nanocomposite separator and/or membrane is generally positioned between the electrodes of the electrochemical device. More generally, the nanocomposite separator and/or membrane is positioned between the anode and cathode of the battery.

### EXAMPLES

The following examples are provided to illustrate certain embodiments of the invention and are not to be construed as limitations on the invention, as set forth in the appended claims. All parts and percentages are by weight unless otherwise specified.

### Example 1

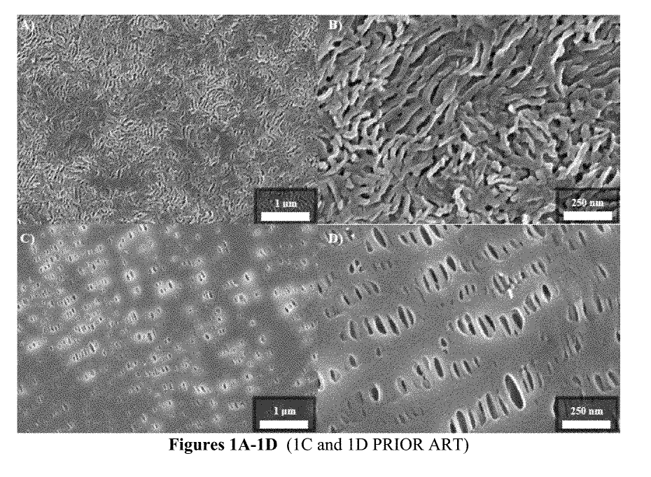

Nanoporous battery separator morphology was characterized using scanning electron microscopy. The nanoporous battery separators were coated with iridium. The thickness of the iridium coating, as determined by scanning electron microscopy, was about 2 nm. The coated nanoporous battery separators comprised nanoporous polyethylene (NPE) polyactide block polymers (see FIGS. 1A and 1B). The nanoporous battery separators had a high weight fraction of polylactide in the block polymer. The weight fraction of polyactide in the nanoporous battery separators was about 65 wt %. The coated nanoporous battery separators had a bicontinuous cubic morphology. The nanoporous separators also had a percolating pore morphology. The pores of the nanoporous battery separators also had a narrow pore size distribution and a high porosity. This is in comparison, to commercial separators (see FIGS. 1C and 1D) which generally have a broad pore size distribution and relatively low void fraction. This broad pore size distribution and relatively low void fraction of commercial separators are known artifacts of commercial separators and believe to be due to the cold drawing of commercial separators.

### Example 2

Battery performance is generally related to wettability of the battery separator. Increases in separator wettability typically correlate with increases in one or more of separator and cell resistance. Moreover, cell manufacture efficiency is generally relatable to electrolyte filling time, which are commonly aspects strongly tied to electrode and separator wettability.

Wettability and wetting time of a separator are usually related to one or more separator surface energy, pore size, porosity and pore tortuosity. Wicking rate and contact angle measurements are common separator wettability measurements. Separator wettability can be determined by measuring, after application of an electrolyte droplet on the separator surface, the droplet's contact angle and rate of wicking.

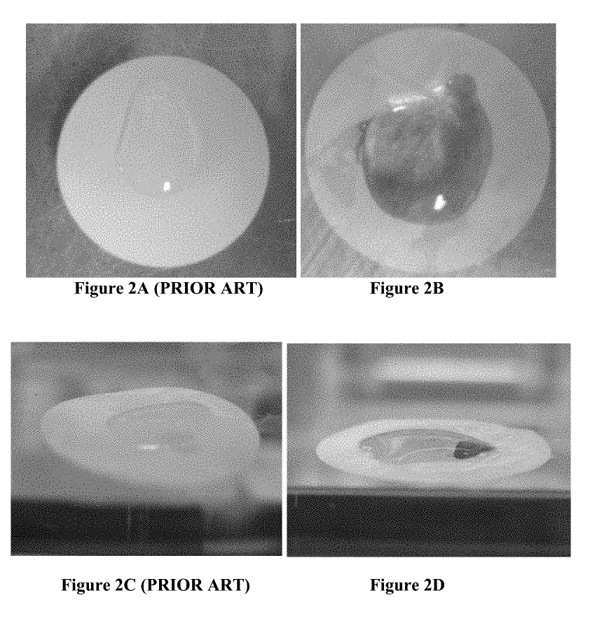

FIGS. 2A and 2B, respectively, depict electrolyte wicking of lithium-ion battery electrolyte for a commercial separator and a nanoporous separator according to some embodiments of the present disclosure. The nanoporous separator shows much better wicking (spreading and sorption) of the lithioum-ion battery electrolyte, compared with the commercial separator.

The contact angle is defined as the angle formed by the intersection of the liquid-solid interface and the liquid-vapor interface (geometrically acquired by applying a tangent line from the contact point along the liquid-vapor interface in the droplet profile). FIGS. 2C and 2D, respectively, depict lithium-ion battery electrolyte contact angles for the commercial and the nanoporous battery separators. The contact angles were determined to be 31° for the nanoporous separator and 69° for the commercial battery separator. A smaller contact angle corresponds to greater lithium-ion battery electrolyte wettability, which is consistent with the wicking measurements.

### Example 3

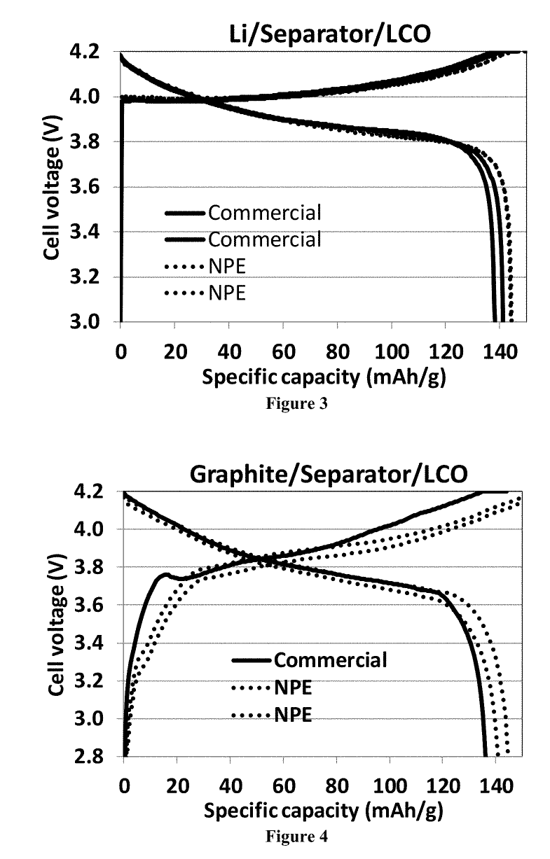

Electrochemical test were conducted with battery coin half-cells comprising a commercial battery lithium cobalt oxide cathode, a lithium metal anode, and a lithium-ion battery electrolyte, with either the nanoporous battery separator or a typically commercial separator. The battery coin half-cells were cycled at a C/4 rate at room temperature during formation. FIG. 3 shows charge/discharge voltage versus specific capacity during formation for the half-lithium/lithium cobalt oxide battery coin half-cells having a commercial separator and those having the nanoporous battery separators. The nanoporous battery separator-based lithium/lithium cobalt oxide coin half-cells displayed characteristic lithium cobalt oxide battery voltage profiles versus lithium/lithium ion and delivered an equivalent, to somewhat slightly greater, i.e., 123.2 mAh/g vs. 120.1 mAh/g, on average, based on the lithium cobalt oxide cathode active material weight specific capacity, compared to analogous coin battery half-cells having the commercial separator.

### Example 4

Electrochemical tests were conducted with battery coin full-cells comprising a commercial battery lithium cobalt oxide cathode, a graphite anode, and a lithium-ion battery electrolyte, with either the nanoporous battery separator or a typically commercial separator. The battery coin full-cells were cycled at a C/4 rate at room temperature during formation. FIG. 4 shows charge/discharge voltage versus specific capacity during formation for the battery coin full-graphite/lithium cobalt oxide battery coin full-cells having a commercial separator and those having the nanoporous battery separators.

The nanoporous battery separator-based graphite/lithium cobalt oxide battery coin full-cells displayed characteristic lithium cobalt oxide battery voltage profiles versus graphite/lithium cobalt oxide and delivered an equivalent, to somewhat slightly greater, i.e., 122.2 mAh/g versus 117.1 mAh/g, on average, based on the lithium cobalt oxide cathode active material weight specific capacity, compared to analogous coin battery full-cells having the commercial separator.

### Example 5

FIG. 5 shows the specific discharge capacity versus cycle number for a graphite/lithium cobalt oxide coin battery full cell with a nanoporous battery separator cycled at 0.25C rate (charge and discharge). These data are overlaid with similar data for analogous cells having commercial separators. The full battery cells having the nanoporous battery separator maintained a steady capacity retention trend over the initial 300 cycles with more than >86% of capacity retention.

### Example 6

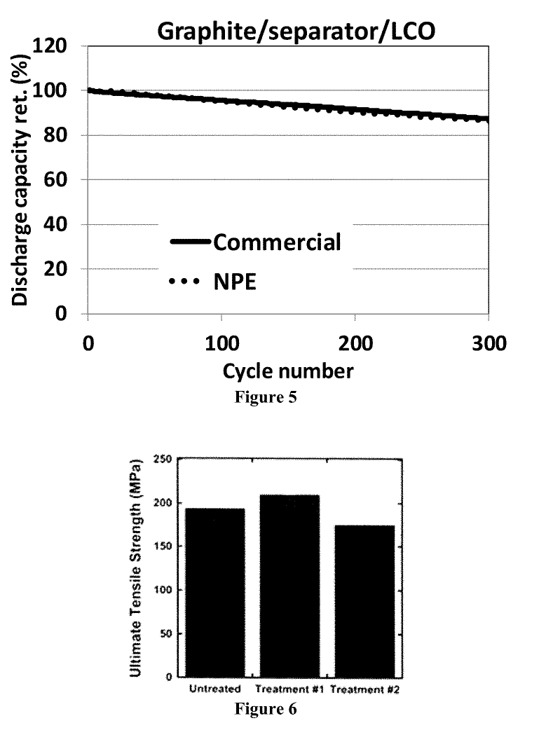

FIG. 6 shows average tensile strength of ceramic-coated nanoporous battery separators versus an untreated nanoporous battery separator. The ceramic coating comprised alternative layers of atomic layer deposited aluminum oxide (Al₂O₃) and molecular layer deposited alucone (an aluminum oxide polymer generally comprising sequential exposures of trimethylaluminum, Al(CH₃)₃ and hydroquinone, C₆H₄(OH)₂], a hybrid organic-inorganic polymer film. The ceramic coating (labeled as Treatment #1) increased the mechanical tensile strength of the nanoporous battery separator compared to the untreated nanoporous battery separator (labeled as control). An increase of 10% tensile strength represents the ability to reduce the battery separator thickness in a non-linear manner. This provides mass savings leading to significant energy density improvement.

### Example 7

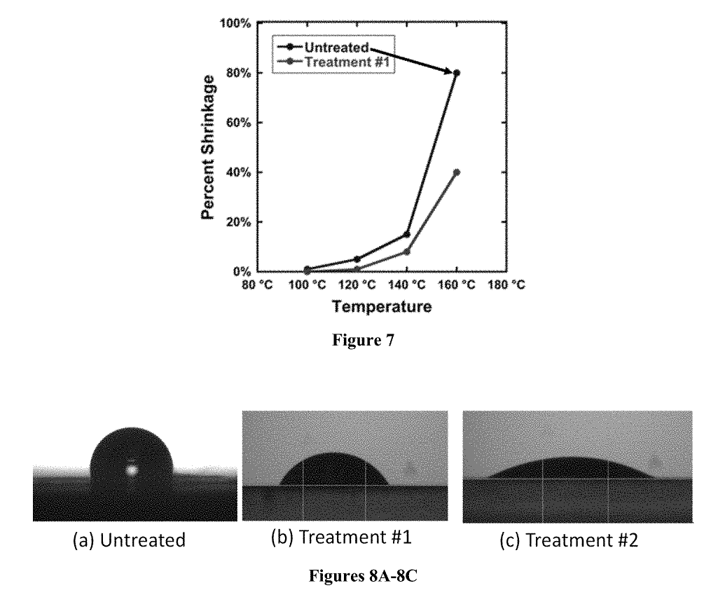

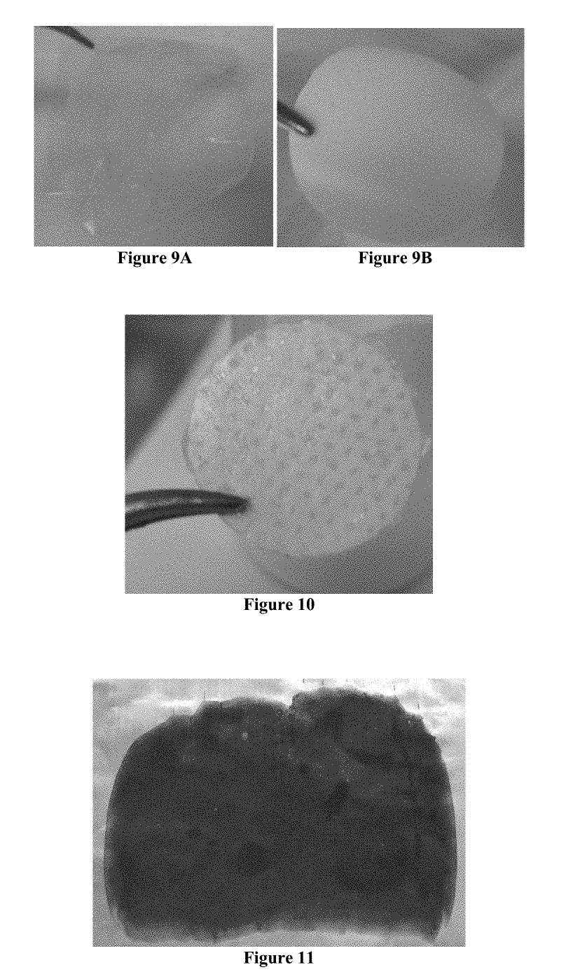

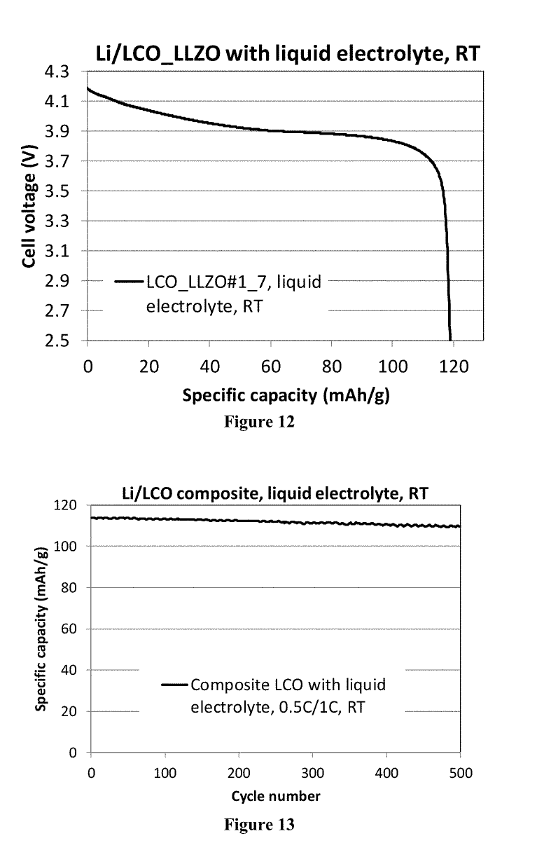

FIG. 7 shows separator percent shrinkage as a function of temperature. The ceramic-coated nanoporous battery separators (i.e., Treatment #1) demonstrated a significant reduction in thermal shrinkage, with the best results representing an improvement of more than about 40% at 160° C., compared to an untreated nanoporous battery separator. The superior temperature resistance demonstrated by the ceramic-coated nanoporous battery separator is ideally suited for battery applications such as electric vehicles where safety is paramount.

### Example 8

FIGS. 8A-8C show contact angle measurements of an electrolyte on ceramic-coated nanoporous battery separators. The contact angle measurements demonstrated much smaller electrolyte contact angles of 53.4° and 29.1° for Treatment #1 and #2, respectively, compared with the untreated nanoporous sample (contact angle of 98.1°). Smaller electrolyte contact angles correspond to enhanced rate of electrolyte wetting (i.e., wettability) and the amount of electrolyte absorbed and retained by the battery separator when the cell is in operation, which improve cell operation. A maximum amount of electrolyte in the separator is desirable to minimize energy storage device (e.g., battery or supercapacitor) cell internal resistance. Smaller cell internal resistance leads to much improved energy storage device (e.g., battery or supercapacitor) operation that results in increased power capability, reduced ohmic heat loss and increased energy storage device (e.g., battery or supercapacitor) life. These attributes are critical to the electrochemical energy storage device (e.g., batteries or supercapacitors) applications, such as, electric drive vehicles.

### Example 9

Polyethylene oxide has polar oxygen groups, the O—C linkages, which can act as solvents and dissolve lithium salts to form stable ion-polymer complexes with salts, such as lithium salts, e.g., LiPF₆. While not wanting to be bound by theory, it is believed that the ion-conducting mechanism of the polyethylene oxide polymer electrolyte is due to cation hopping between ion coordination sites on one chain (intrachain hopping) or between neighboring chains (interchain hopping) due to motions of flexible polymer segments (local relaxation process). Hopping mechanism can also involve ion clusters. The flexible, amorphous phases in the polyethylene oxide polymer can be responsible for fast ionic transport. The ionic transport within the amorphous phase can depend on the molar ratio of ethylene oxide to salt (or ions).

### Example 10

Solid-state electrolyte separators were prepared with polyethylene oxide polymer and lithium hexafluorophosphate (LiPF₆). The polyethylene oxide polymer had an average molecular weight of 600,000 Daltons. The lithium hexafluorophosphate is an ionic salt. The molar ratio of ethylene oxide to the ionic (or lithium hexafluorophosphate or lithium ions) was about 10:1, a design for a high amorphous phase fraction in the polyethylene oxide polymer and for high ionic conductivity. The separator also included a solid electrolyte ceramic filler, cubic garnet Li₇La₃Zr₂O₁₂ with a nominal conductivity of about 5×10⁻⁴ S/cm at room temperature. 30 parts by weight polyethylene oxide, 10 parts by weight LiPF₆ and 60 parts by weight Li₇La₃Zr₂O₁₂ were mixed with acetonitrile (as a solvent), then cast on a metal sheet or release sheet and cured or dried to form the sold-state electrolyte separator (depicted in FIGS. 1A and 1B).

### Example 11

The polyethylene oxide, lithium hexafluorophosphate and Li₇La₃Zr₂O₁₂ mixture in acetonitrile (of Example 10) was cast onto a spunbond polypropylene fabric and a composite solid-state separator with a reinforcing fabric was formed after curing and/or drying (see FIG. 2).

### Example 12

A cathode comprising a garnet ion conductor was fabricated. A slurry of 60 parts by weight lithium cobalt oxide, 30 parts by weight cubic garnet Li₇La₃Zr₂O₁₂, 5 parts by weight conductive carbon black (such as Super-P) and 5 parts by weight polyvinylidene (HSV900) was prepared and cast onto a current collector (such as an aluminum collector), see FIG. 3.

### Example 13

A solid-battery cell was formed with the solid-state separator of Example 11, the cathode of Example 10 and a lithium metal anode. The lithium metal anode and the cathode were bonded and/or pressed onto the solid-state separator. A coin battery cell was formed by cell stacking of the solid-state battery cells.

### Example 14

In this example, a solid-state battery cell having a liquid electrolyte will be electrochemically evaluated. The solid-state battery cell was prepared according Example 13, the battery has a lithium cobalt oxide cathode prepared according Example 12, a lithium anode, a lithium-ion liquid electrolyte comprising 1M lithium hexafluorophosphate in a carbonate solvent mixture, and a polyolefin microporous separator. The solid-state battery cell formation cycle test protocol included room temperature charging and a discharging of the battery between 2.5-4.2V at a C/4 rate.

The lithium cobalt oxide cathode delivered a full discharge specific capacity, 120 mAh/g, as shown in FIG. 4 and demonstrated good compatibility and stability when cycled at the voltage range 2.5V-4.2V.

### Example 15

The cycle life protocol for the battery cell of Example 14 included room temperature charging and discharging between about 3 to about 4.2V at C/2 and 1C rates, respectively. The battery cell demonstrated excellent long-term cycle life performance, with 96% capacity retention after 500 charge/discharge cycles as shown in FIG. 13. The solid-state battery cells with a lithium-ion liquid electrolyte also had excellent compatibility and stability of the lithium cobalt oxide cathode when cycled at a voltage range of from about 3 to about 4.2V (vs. Li/Li⁺).

### Example 16

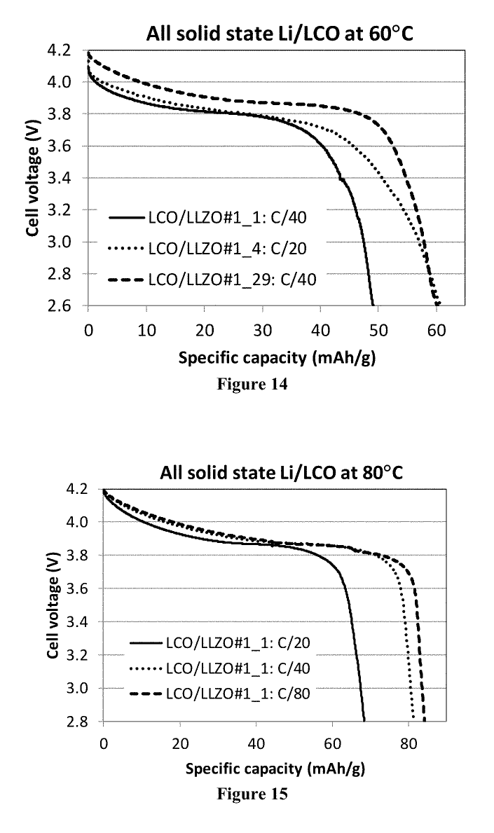

Solid-state battery cells were prepared according to Example 13 (without any liquid electrolyte) and subjected to formation cycles at 60 degrees Celsius between about 2.5 to 4.2V at rates of C/20 and C/40. FIG. 14 shows discharge voltage profiles of theses solid-state battery cells during the formation cycles at 60 degrees Celsius.

Table 1 shows the discharge capacities of these solid-state battery cells in caparison with a control battery cell (prepared according to Example 14 with a liquid electrolyte). The solid-state battery cells delivered up to about 52% of the nominal specific capacity of the control battery cells. This performance demonstrates stable operation of these solid-state cells at about 60 degrees Celsius at the cycled voltage range of from about 2.5 to about 4.2V.

TABLE 1

| | Discharge | Specific Capacity | Capacity |
|---|---|---|---|
| ID | Rate | (mAh/g) | versus Control |
| Control | — | 119.1 | 1.00 |
| 1 | C/40 | 50.0 | 0.42 |
| 2 | C/20 | 61.6 | 0.52 |
| 3 | C/40 | 60.2 | 0.51 |

### Example 17

Solid-state battery cells were prepared according to Example 13 (without any liquid electrolyte) and subjected to about 80 degrees Celsius cyclic formation between about 2.5 to about 4.2 volts cyclic rates of C/20, C/40 and C/80. FIG. 15 shows discharge voltage profiles of theses solid-state battery cells during the formation cycles at a temperature of about 80 degrees Celsius.

Table 2 shows the discharge capacities of these solid-state battery cells in caparison with a control battery cell (prepared according to Example 14 with a liquid electrolyte). The solid-state battery cells delivered up to about 71% of the nominal specific capacity of the control battery cells. This performance demonstrates stable operation of these solid-state cells at about 80 degrees Celsius at the cycled voltage range of from about 2.5 to about 4.2V.

TABLE 2

| | Discharge | Specific Capacity | Capacity |
|---|---|---|---|
| ID | Rate | (mAh/g) | versus Control |
| Control | — | 119.1 | 1.00 |
| 1 | C/20 | 68.5 | 0.58 |
| 2 | C/40 | 81.4 | 0.68 |
| 3 | C/80 | 84.3 | 0.71 |

### Example 18

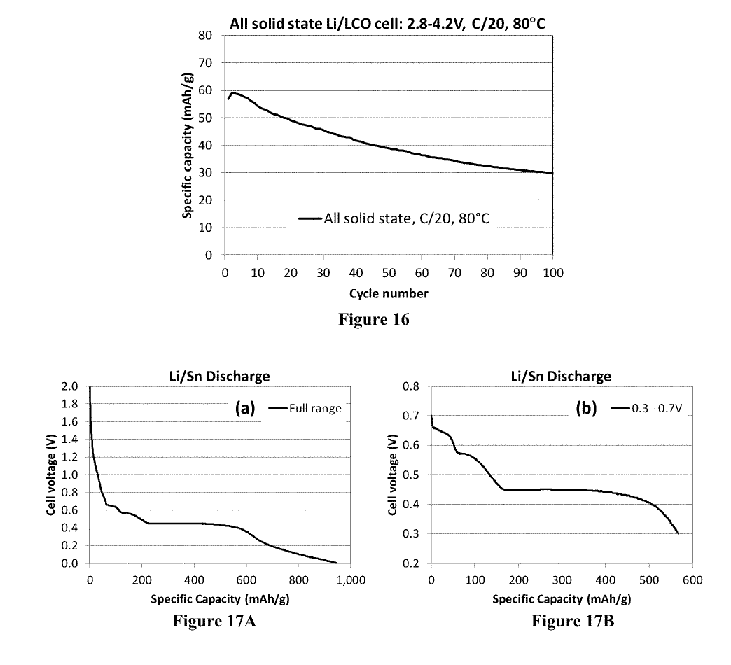

Solid-state battery cells were prepared according to Example 17 and subjected to formation cycles at 80 degrees Celsius between about 2.5 to 4.2V at C/20 current rate. FIG. 16 shows discharge specific capacity vs. cycle number of these solid-state battery cells. The solid-state battery cells had a gradual capacity fade against cycling at about 80 degrees Celsius, with more than about 50% capacity retention after 100 cycles. The cycle life demonstrated compatibility and stability of the cell components with high temperature and cycled voltage range (from about 2.8 to about 4.2V vs. Li/Li⁺) and a solid electrolyte membrane that is mechanically robust to serve as one or more of an ionic conductor (transport ionic species like a battery electrolyte) and an electronic insulator (be an electrical insulation function of a battery separator).

### Example 19

FIG. 17A shows the full voltage discharge voltage profile of a lithium/tin battery between about 0 to about 2.0 volts, the full voltage range of the battery. FIG. 17B shows the discharge profile within the 0.3 to 0.7 voltage range, the operational range of the battery. The plateau-like features within the 0.3 to 0.7 voltage range correspond to a series of phase transformations corresponding with increasing lithium to tin alloy content. The plateau at about 0.65 volts is believed to be due to the transition from pure tin, with a lithium-to-tin ratio of 0, to the lithium-tin alloy Li₂Sn₅, with a lithium-to-tin ration of 0.4, while the plateaus at about 0.57 and 0.45 volts are believed to correspond to transitions from Li₂Sn₅ to the LiSn (with respective lithium-to-tin ratios of 0.4 to 1.0) and then from LiSn to Li₅Sn₂ (with respective lithium-to-tin ratios of 1.0 to 2.5). The longest discharge voltage plateau observed at about 0.45 V, corresponds to a desirable and large specific capacity of about 570 mAh/g. Below about 0.3 V, the discharge profile corresponds to a lithium-rich, lithium-tin alloy region with further lithiations of the tin; which are believe to respectively correspond to alloy transformations from Li₅Sn₂ to Li₁₃Sn₅ (from a lithium-to-tin ratio of 2.5 to 6.5), followed by Li₇Sn₂ (with a lithium-to-tin ratio of 3.5), and finally to Li₂₂Sn₅ (with a lithium-to-tin ratio of 4.4), the maximum theoretical lithium content for a lithium-tin alloy. The total discharge specific capacity found across the full voltage range is 994.6 mAh/g. At voltages of more than about 0.7 V, the battery has a specific capacity of about 60 mAh/g or about 6% of its total specific capacity, which can easily be removed by initial battery conditioning protocols. The lithium-tin electrochemical pair have usable capacity for low voltage applications.

### Example 20

A range of cathode constituents (such as, conductive additives and binders), formulations (such as, amounts of active material, conductive additives and binders), and processes for constituent homogenization and uniform electrode film fabrication (such as, slurry mixing, casting, drying and densification) were evaluated. A cathode constituents, formulations and processes for homogenization and electrode fabrication were evaluated for tin particle-to-particle connection across the entire battery discharge voltage range. The conductive additives evaluated were high surface area carbon black, conductive graphite, dispersed carbon nanotubes, and a carbon nanotube-graphene dispersed mixture. The binders that were polyvinylidene fluoride, styrene-butadiene copolymer. The polyvinylidene fluoride binder was also evaluated in various organic solvents, while styrene-butadiene copolymer was evaluated in an aqueous solvent.

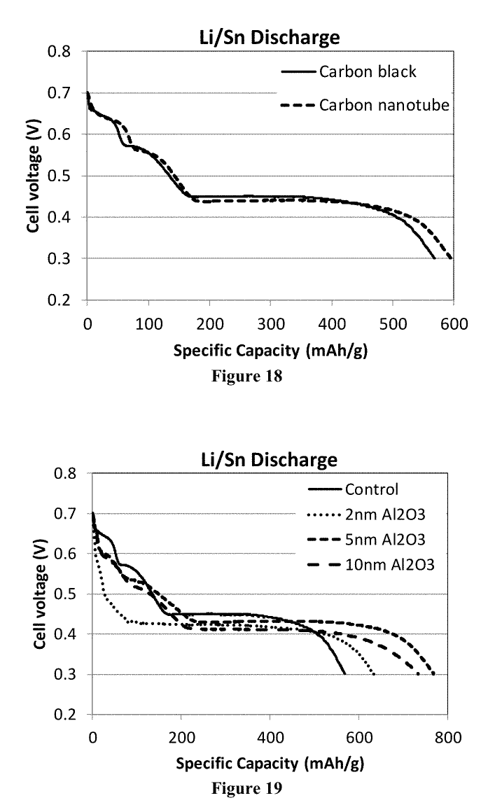

FIG. 18 presents lithium/tin battery voltage profiles for tin cathodes having carbon black, carbon nanotubes or a mixture thereof as the electrically conductive additive. A conductive additive concentration of 10% by weight in the tin cathode was maintained from sample to sample. Battery cells having carbon nanotube as the conductive additive in the tin electrode delivered about 5% greater specific capacity than those having carbon black as the conductive additive, when operated in the voltage range of about 0.3 to about 0.7 V (i.e., at about 595.3 mAh/g versus. About 568.2 mAh/g). It is believed that the inclusion of well-dispersed carbon nanotubes provided improved connectivity between the tin particles owing to the carbon nanotubes greater aspect ratio (about 1000 or more) than that of carbon black particles (aspect ratio of about 1). This difference in aspect ratio is responsible for effectively maintaining tin particle-to-particle interconnectedness during discharge when the tin particles are alloying with lithium.

### Example 21

Amorphous aluminum oxide or alumina (Al₂O₃) thin films were deposited on tin electrodes by atomic layer deposition. A custom-built flow-tube reactor was used for the atomic deposition process. Trimethylaluminum and water were used as gaseous precursors for the aluminum oxide atomic layer deposition process. The films were deposited at a temperature of about 90 degrees Celsius to avoid tin electrode oxidation. Aluminum oxide films coating thicknesses of 2, 5 and 10 nm were evaluated. Coating thicknesses were confirmed on an atomic layer “monitor” silicon wafers using ellipsometry at 1.8, 5.2 and 9.7 nm.

FIG. 19 presents the voltage profiles for a lithium/tin battery cells with and without atomic layer deposited aluminum oxide coatings on the tin electrodes. The battery cells having an atomic layer deposited aluminum oxide coating had a significant increase in specific capacity. Compared with a control battery cell having a tin electrode lacking a coating of atomic layer deposited aluminum oxide, the battery cells having a tin electrode with an atomic layer deposited aluminum oxide coating thickness of about 2, 10 and 5 nm had, respectively, about 11%, 29% and 35% higher specific capacity (Table 3). The increases in specific capacity resulted from prolonged voltage plateau enhancements between about 0.41 and about 0.43 Volts. This represents a particularly relevant and attractive result for near zero power devices. It is believed that the atomic layer deposited aluminum oxide (Al₂O₃) coatings function as a media to facilitate enhanced tin particle connectivity. It is further believed that the atomic layer deposition of an aluminum oxide coating increases electrolyte accessibility and lithium ion diffusion through the coating. While not wanting to be bound by any theory, the atomic layer deposited coating is believed to increase the tin particle surface area, such as without limitation increase the internal pores surface area of the tin particles. Such a phenomenon is believed to significantly improve tin active material participation in the electrochemical reaction in the cell.

TABLE 3

| | | Atomic Layer | Specific | Capacity |
|---|---|---|---|---|
| | Conductive | Coating of | Capacity | versus |
| Sample | additive (10%) | Al₂O₃ | (mAh/g) | Control |
| Control | Carbon Black | No | 568.2 | 100 |
| Pristine Tin | Carbon | No | 595.3 | 105 |
| | Nanotubes | | | |
| 2 nm Al₂O₃ on | Carbon Black | Yes | 633.0 | 111 |
| control | | | | |
| 5 nm Al₂O₃ on | Carbon Black | Yes | 768.6 | 135 |
| control | | | | |
| 10 nm Al₂O₃ | Carbon Black | Yes | 734.0 | 129 |
| on control | | | | |

### Example 22

Table 4 compares the lithium/tin batteries according some embodiments of the present disclosure with the alkaline, silver oxide, zinc air and mercury oxide the prior art R44 battery formats. The lithium/tin batteries of the present disclosure compare favorably in all aspects, and offer potential capacity and lifetime advantages.

TABLE 4

| | | | | | |
|---|---|---|---|---|---|
| Chemistry | Alkaline | Silver Oxide | Zinc Air | Mercury | Lithium/Tin |
| | | | | Oxide | Present |
| | | | | | Disclosure |
| Common | LR44, | SR1154, | PR44, PR675 | MR1154, | R44 |
| Name | LR1154, | SR44, | | MR44 | |
| | L1154 | SR44SW | | | |
| Typical | 100-120 mAh | 200 mAh | 600-650 mAh | 200 mAh | 450 mAh |
| Capacity | | | | | |
| Nominal | 1.5 V | 1.5 V | 1.4 V | 1.35 V | 0.5 V |
| Voltage | | | | | |
| Notes | Typical LR44 | Slightly | Slightly Lower | Contains | 0.3 to 0.7 V |
| | Battery | Higher | Voltage, | Mercury, | Higher Energy |
| | | Voltage | Higher | Withdrawn | at Lower |
| | | | Capacity | | Voltage |

### Example 23

Sulfur powders were acquired from US Research Nanomaterials. The sulfur powders had an average mean particle size of about 47 nm, purity of 99.99%, and orthorhombic crystal structure. The sulfur powders were coated with Al₂O₃ by an atomic layer deposition process. The atomic layer deposition process was conducted at a temperature of about 100 degrees Celsius and for various number of cycles (Table 5). Following the deposition process, the coated sulfur samples appeared chunky (some large grains). The Al₂O₃-coated sulfur samples were pestle and mortar ground before slurry coating into sulfur-based electrodes. The Al₂O₃-coated sulfur powders may “sinter” (or undergo “sintering-like” processes) at moderate temperatures of about 100 degrees Celsius, becoming discolored and clumpy, so a low deposition temperature of about 80 degrees Celsius is recommended.

TABLE 5

| | Number of Atomic Layer |
|---|---|
| Sample ID | Deposition Cycles of Al₂O₃ |
| Control | None |
| 1 | 10 |
| 2 | 50 |
| 3 | 100 |

### Example 24

Sulfur-based cathodes were prepared from the samples of Table 5. Slurries were prepared for each sample (the control and each of samples 1-3). The slurries comprised 75 wt % of a sulfur composition (of Table 5), 15 wt % conductive carbon, 5 wt % conductive graphite and 5 wt % binder. The slurries were coated onto an aluminum or a carbon-coated aluminum foils to fabricate sulfur-based cathodes. The slurry-coated cathodes were dried, after which they were densified using a roll calendering unit. Coin battery cells, CR2031, were fabricated using the sulfur-based cathodes, lithium anodes, and a battery electrolyte. The battery electrolyte was 1M lithium bis(trifluoromethane)sulfonamide in 1,3-dioxolane/1,2-dimethoxyethane 1:2 vol. %, with a 1.5 wt % of lithium nitrate additive. The coin battery cells were cycled at a C/10 rate at room temperature during formation cycles.

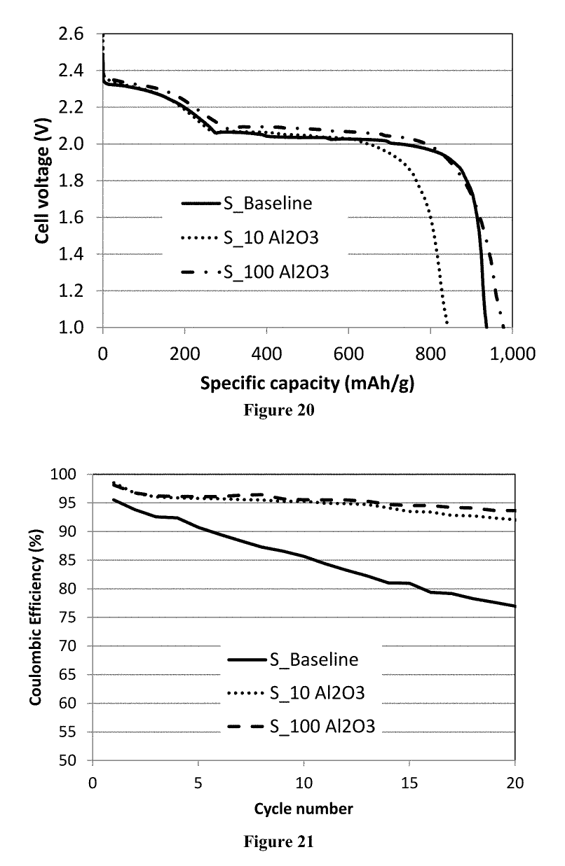

FIG. 20 shows the first discharge voltage profiles for the formation cycles of the coin cells having sulfur-based cathodes. The sulfur-based cathodes comprising the Al₂O₃-coated sulfur sample 3 showed a larger specific capacity than the baseline sample (978.2 mAh/g vs. 936.9 mAh/g). The results show that atomic layered Al₂O₃-coated on sulfur powder can provide increased sulfur active material utilization. The atomic layer deposition of Al₂O₃ on sulfur increased the inherent specific capacity of sulfur during one or more of the discharge and lithiation of sulfur.

### Example 25

Coin cells prepared according to Example 24 were cycled at C/2 rate at room temperature. FIG. 21 shows the cycle performance in terms of coulombic efficiency as a function of cycle number for the first twenty cycles. Coulombic efficiency is defined as the ratio (expressed as a percentage) between the discharge and the charge capacities. Coin cells prepared with Samples 1 (10 cycles and/or layers) of Al₂O₃ atomic layer deposition) and 3 (100 cycles and/or layers of Al₂O₃ atomic layer deposition) showed higher initial coulombic efficiency compared with the control coin cell (98.1% vs. 95.6%). The coin cells prepared with samples 1 and 3 also showed steadier coulombic efficiencies against cycling than the control coin cell. At 20^{th} cycle, the coin cells having cathodes prepared with either of samples 1 and 3 also maintained a coulombic efficiency of more than about 93%, while the coulombic efficiency of the control coin cell declined to about 77%. Higher coulombic efficiency is advantageous since it represents a more efficient energy storage device with diminished capacity/energy losses due to one or more of, chemical or electrochemical side reactions, self-discharge, etc.

### Example 26

In this example, a commercial battery separator, Celgard ECT2015, was coated with Al₂O₃ by atomic and layer deposition of the Al₂O₃. Table 6 lists the coated separator sample numbers, coating conditions and parameters, where the atomic layer deposited Al₂O₃ and molecular layer deposited alucone, using sequential exposures to trimethylaluminum and ethylene glycol, were consecutively coated on the commercial separator. Separator sample S1 was prepared as follows. 25 atomic layer deposition cycles of Al₂O₃ was first coated on the commercial separator substrate, followed by repeating two times, 25 cycles of molecular layer deposition of alucone followed by 25 cycles of atomic layer deposition of Al₂O₃. The other separator samples were prepared similarly, separator sample S2 (25 cycles of atomic deposited Al₂O₃ followed repeating two times, 30 cycles alucone followed by 20 cycles of atomic deposited Al₂O₃) S3 145 cycles of atomic deposited Al₂O₃ followed repeating two times, 14 cycles alucone followed by 14 cycles of atomic deposited Al₂O₃), and S4 (1 cycle of atomic deposited Al₂O₃ followed repeating two times, 15 cycles alucone followed by 1 cycle of atomic deposited Al₂O₃) were prepared in a similar fashion, as shown in Table 6. The atomic and molecular layer depositions were 80 degrees Celsius and the commercial separator was not plasma pretreated.

TABLE 6

| | | | | No. times atomic |
|---|---|---|---|---|
| | Initial No. of Al2O3 | No. cycles of | No. cycles of Al2O3 | and molecular |
| | Atomic layer | alucone molecular | atomic layer | deposition |
| Sample ID | deposition cycle(s) | layer deposition | deposition | repeated |
| Separator | None | none | none | None |
| Control | | | | |
| S1 | 25 | 25 | 25 | 2 |
| S2 | 25 | 20 | 20 | 2 |
| S3 | 14 | 14 | 14 | 4 |
| S4 | 1 | 15 | 1 | 2 |

### Example 27

The separator samples of Example 26 were used to prepare battery coin cells according to Example 24. The prepared battery coin cells were cycled at a C/10 rate at room temperature during formation cycles.

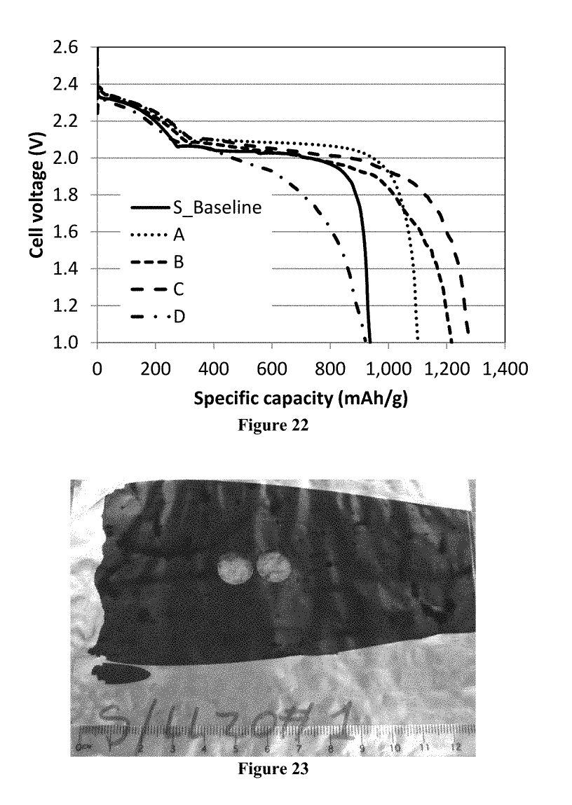

FIG. 22 shows the first discharge voltage profiles of the prepared battery coin cells during the formation cycles. The battery cells prepared with separator samples S1, S2 and S3 showed significantly increased discharge specific capacity. The coin cell having separator S3 had a discharge specific capacity of about 37% more than the coin cell having the control separator. The results show that atomic Al₂O₃— and molecular alucone-coated layers on sulfur powder can provide increased sulfur active material utilization. The atomic and molecular layer depositions of Al₂O₃ and alucone on sulfur increased the inherent specific capacity of sulfur during one or more of the discharge and lithiation of sulfur.

TABLE 7

| | Specific Capacity | Specific Capacity |
|---|---|---|
| Separator | (mAh/g) | versus Control |
| Control | 936.9 | — |
| S1 | 1101.5 | 1.18 |
| S2 | 1216.6 | 1.30 |
| S3 | 1280.4 | 1.37 |
| S4 | 922.0 | 0.98 |

### Example 28

Composite sulfur-based cathodes where fabricated. The sulfur-base cathode comprises sulfur, Li₇La₃Zr₂O₁₂, a conductive carbon black and a binder. A slurry mixture of the sulfur, Li₇La₃Zr₂O₁₂, conductive carbon black and binder is cast on a current collector and dried and cured. FIG. 23 depicts a sulfur-based cathode comprising an aluminum collector coated with composition having 60 wt % Li₇La₃Zr₂O₁₂, 10 wt % conductive carbon black (Super-P), and 5 wt % polyvinylidene fluoride as the binder (HSV900).

### Example 29

A solid-state battery was constructed by forming a solid-state electrolyte separator of Example 14 on a composite sulfur-based cathode of Example 28, and a lithium metal anode. The lithium metal anode and the composite sulfur-based cathode were bonded and/or pressed onto the solid-state electrolyte separator. A battery coin cell was built after a cell-stack of the solid-state batteries.

### Example 30

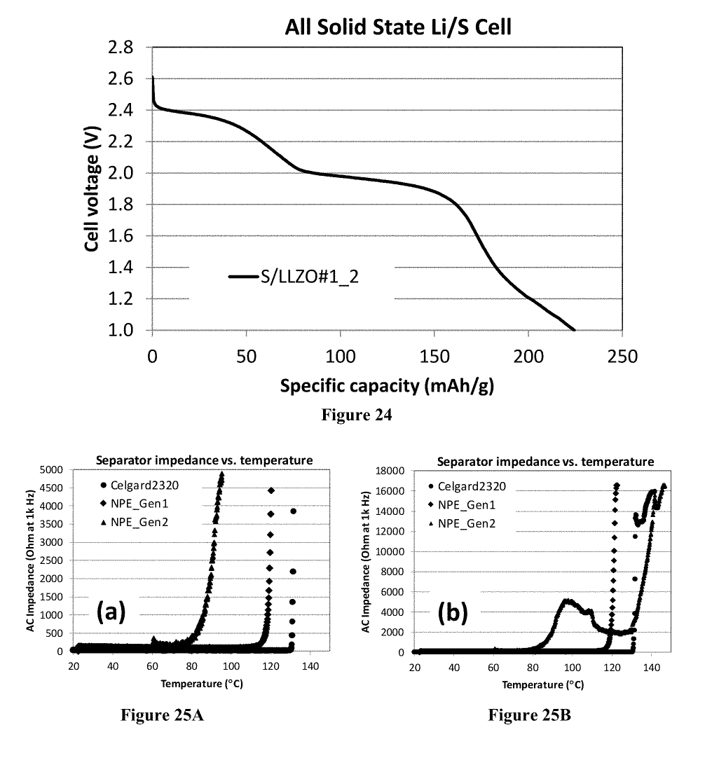

The battery coin cell of Example 29 was subjected to formation cycle. FIG. 24 shows the discharge voltage profile of the battery coin cell at about 80 degrees Celsius at a C/40 rate between about 1 to about 3 V.

### Example 31

In this example separator thermal shut-down the presence of cell electrolyte was investigated. A total of seven electrolyte formulations were evaluated (see Table 8). Electrolytes were formulated for high temperature durability (no deterioration at the temperature of evaluation) and high ionic conductivity (to ensure good signal to noise ratio to capture separator thermal shutdown performance). The best electrolyte formulation was NSE#6 which comprised 0.5M LiPF₆ and 0.5M LiBF₄ in diethyl carbonate.

Coin cell hardware CR2032 for separator thermal shutdown evaluations. Celgard 2400 (polypropylene, MP=160° C.) was used as the separator support. All separator samples were wetted with NSE#6 and sandwiched between stainless steel spacers. Cell impedance was measured as a function of temperature. The coin test cells were positioned inside an environmental chamber and connected to a battery cycler (Maccor cycler from Maccor Inc.). The battery cycler instrument's internal impedance measurement capability at 1 kHz was used to evaluate separator coin cell impedance as a function of temperature. A commercial separator (Celgard 2320, polypropylene/polyethylene/polypropylene trilayer).

TABLE 8

| Electrolyte | Electrolyte Formulation |
|---|---|
| NSE #1 | 0.5M LiPF₆, 0.5M LiBF₄ in EC:PC 1:2 vol % |
| NSE #2 | 1M LiBF₄ in EC:PC 1:1 vol % |
| NSE #3 | 1M LiBF₄ in PC |
| NSE #4 | 1M LiBF₄ in GBL |
| NSE #5 | 1M LiBF₄ in DEC |
| NSE #6 | 0.5M LiPF₆, 0.5M LiBF₄ in DEC |
| NSE #7 | 0.5M LiPF₆, 0.5M LiBF₄ in PC |

EC = ethylene carbonate,
DEC = diethyl carbonate,
PC = propylene carbonate,
GBL = γ-butyrolactone,
LiPF₆ = lithium hexafluorophosphate,
LiBF₄ = lithium tetrafluoroborate.

### Example 32

FIGS. 25A and 25B show separator coin cell impedance as a function of temperature, for nanoporous polyethylene Gen1 and Gen2 and Celgard 2320 separators. The environmental chamber chamber was programmed to increase at a very low rate of 0.5 degrees Celsius/minute for accurate temperature shutdown readings/measurements. The impedance rise onset corresponded to 80 degrees Celsius, 115 degrees Celsius and 130 degree Celsius for the nanoporous electrolyte Gen1 and Gen2, and Celgard 2320 separator samples, respectively. Impedance measurement increases as large as one to order of magnitude were observed. These were due to ionic motion reduction resulting from separator thermal shutdown, i.e., micropore closing due to the melting/shrinking of the separator. Large magnitude separator impedance growth provides enhanced safety for lithium-ion batteries. FIG. 25 A shows nanoporous polyethylene separators with lower thermal shutdown temperatures offer further Lithium-ion battery safety by providing more rapid thermal shutdown during abusive events (e.g., short circuit, overcharge).

FIG. 25B shows a second, higher T_{sd} (130° C.) value that corresponds to a greater impedance increase for the nanoporous electrolyte Gen2 samples. We attributed this T_{sd} to the presence of a more populated, higher crystalline, linear polyethylene block that is structurally similar to the poolyethylene layer in Celgard 2320.

In this study, the onset separator impedance rise temperature defined the separator thermal shutdown temperature T_{sd}. The 130 degree Celsius T_{sd} for Celgard 2320 is attributed to the polyethylene layer in the polypropylene/polyethylene/polypropylene trilayer. As noted previously, nanoporous electrolyte Gen1 and Gen2 separators displayed T_{sd} values of 80 degrees Celsius and 115 degrees Celsius, respectively. Thus, nanoporous electrolyte Gen1 and Gen2 separators achieved the primary technical objective of enhanced safety through improved thermal shutdown characteristics.

It is notable that Gen1 separator, i.e., without ethyl polymer block branches, also displayed superior thermal shutdown characteristics as compared to Celgard 2320. We further highlight that nanoporous electrolyte separators offer excellent tunability of other physical properties including porosity, tensile strength, etc. The melting point of a polymer is generally dependent on molecular weight, crystal size (or crystallinity) and chemistry (stiffness). It is believed that the reduced T_{sd} results from the lower crystallinity. Thus, the nanoporous electrolyte Gen1 separator T_{sd} was found to be in qualitative agreeament with the differental scanning calorimetry measurement.

The nanoporous electrolyte Gen2 was based on the inclusion of a branched ethyl polymer block, where an ethyl-branched repeat unit was introduced into the block copolymer chain. This effectively disrupts linear polyethylene backbone crystallinity, which results in further thermal shutdown temperature T_{sd} reduction.

### Example 33

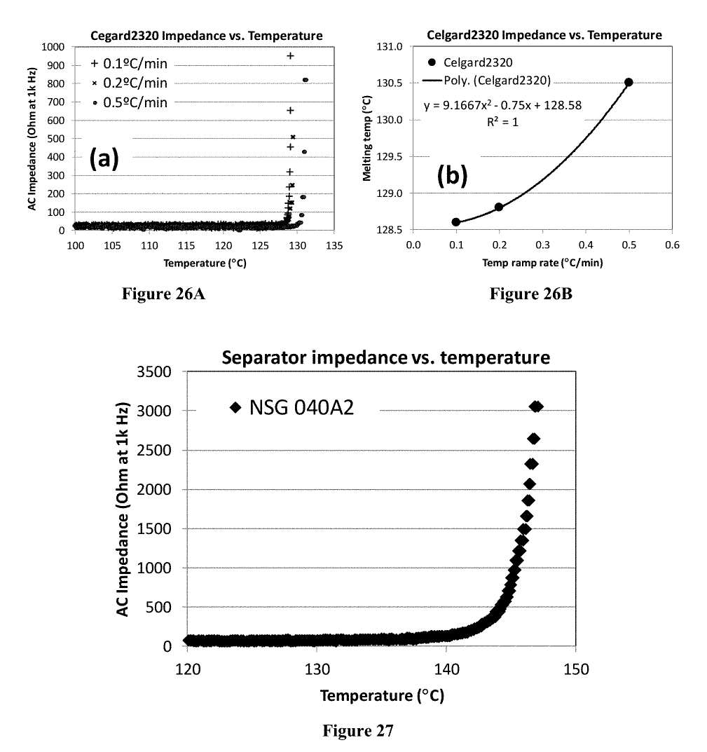

The heating rate on separator cell impedance rise onset temperature was investigated. T_{sd} of Celgard 2320 at various heating rates, i.e., 0.5° C./min, 0.2° C./min and 0.1° C./min. The observed T_{sd} values for the 0.2° C./min and 0.1° C./min heating rates were determined identical (i.e., 0.2° C. apart, FIG. 26), when considering the chamber holds a temperature uncertainly range of ˜0.5° C. This temperature uncertainly in the heating rate T_{sd} measurements and thus, separator thermal shutdown temperature determination. Thus, the T_{sd} values measured at the 0.5° C./min heating rate (reported above) represent quantative but not absolute data points. It is important to note that while these data were ultimately not determined absolute, the comparative results and safety enhancement trends remained valid.

### Example 34

FIG. 27 shows NSG 040A2 separator impedance versus temperature data. The NSG comprises a polyethylene-based, ceramic filler-reinforced, separator having an 80% porosity that affords fast ion transport and thus, high rate/power capability. It further offers excellent thermal (high T_{sd}) and mechanical (high tensile and puncture strength) performance attributed to ceramic silica (silicon dioxide SiO₂) fillers. The NSG 040A2 separator possesses a T_{sd} of 144° C., which is significantly greater than those possessed by Gen1 and Gen2 nanoporous electrolyte separators. In fact, 040A2 possesses enhanced thermal stability when compared to Celgard 2320 (i.e., T_{sd} is 14° C. greater). Since 040A2 is polyethylene based, the increased T_{sd} is attributed to the silica fillers. The high T_{sd} for NSG 040A2 represents an excellent basis for hybrid combination with NPE. In a thermal abuse event, the nanoporous electrolyte separator provides battery rapid thermal shutdown while the NSG 040A2 separator maintains mechanical integrity, due to its much higher T_{sd} NSG 0404A2 thereby displays excellent dimensional stability, which serves to maintain anode physical separation from cathode; this prevents a battery internal short.

### Example 35

In this example shows a capacity evaluation for lithium-ion with safety feature enhanced nanoporous electrolyte separator hybridized with a ceramic filler reinforced supporting separator (040A2) in a coin, full cell format. A commercial graphite anode and lithium-cobalt-oxygen cathode materials, and in a full, coin cell format. Other commercial battery materials, such as, silicon alloy based anode and LiNi_{0.8}Co_{0.15}Al_{0.05}O₂ cathode materials, can also be used.

The anode and cathode were prepared. The graphite anode slurry was coated on a copper metal current collector using an electrode formulation of graphite/conductive carbon/binder ratio of 90/3/7 by weight. The lithium-cobalt-oxygen cathode slurry was coated on an aluminum metal current collector using an electrode formulation of lithium-cobalt-oxygen/conductive carbon/conductive graphite/binder ratio of 88/3.8/3.7/4.5 by weight. The oven dried electrodes were densified with a temperature-controlled, roll calendar machine. The resultant anode and cathode were verified to be high quality via physical assessment. Electrode disks were machined and assembled as graphite/lithium-cobalt-oxygen full, coin cells with CR2032 hardware. A hybrid separator was fabricated as a combination of nanoporous electrolyte (˜12 μm in thickness) with a highly porous, thermal and mechanical stable commercial (separator; 040A2, 40 μm in thickness). The nanoporous electrolyte-based hybrid separator was used in the lithium-ion coin full cells. The electrolyte was 1M LiPF₆ in EC/DMC 1:1 vol. %. The lithium-ion coin full cells were cycled at a C/4 rate at RT during formation cycles.

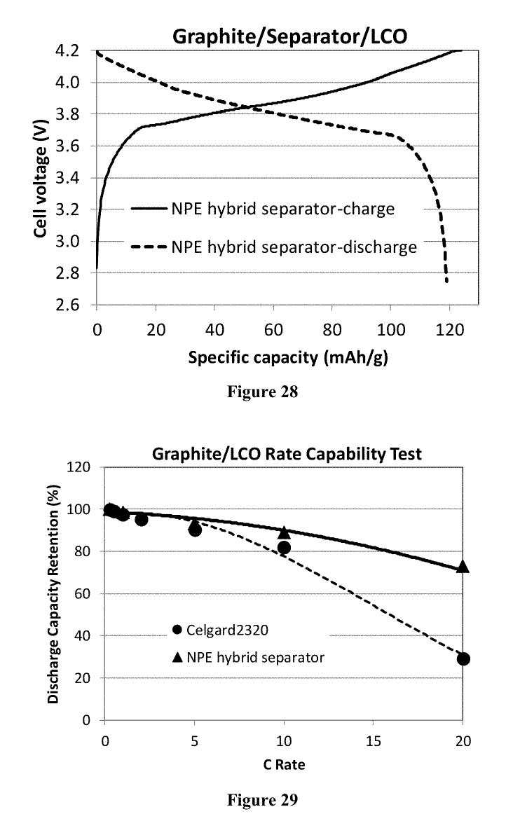

FIG. 28 shows charge/discharge voltage vs. specific capacity during formation for a representative graphite/lithium-cobalt-oxygen full cell using a nanoporous electrolyte-based hybrid separator. The nanoporous electrolyte hybrid separator based lithium-ion full cells displayed characteristic graphite/lithium-cobalt-oxygen voltage profiles and a good discharge specific capacity of ˜120 mAh/g (based on lithium-cobalt-oxygen active mass).

### Example 36

In this example, the rate capability of NPE-based hybrid separator in graphite/lithium-cobalt-oxide full cells was evaluated. A commercial Celgard 2320 separator was also evaluated in otherwise identical lithium-ion full cells for performance comparison purposes. The rate test was conducted at room temperature (23° C.±0.5° C.). The cells were charged at a C/4 current rate. The discharge capacity was measured at various C rates against a low C rate (C/4).

FIG. 29 shows discharge capacity retention (% vs. C/4 rate) vs. C rate for nanoporous electrolyte-based hybrid separator and Celgard 2320 separator in Li-ion full cells. The nanoporous electrolyte-based hybrid separator demonstrated superior rate capability than the commercial Celgard 2320 separator at C rates of about 5C or more. At 20C rate, the nanoporous electrolyte hybrid separator based Li-ion cells demonstrated an impressive rate capability of more than about 73% capacity retention, 2.5× that of Celgard 2320 (29%).

### Example 37

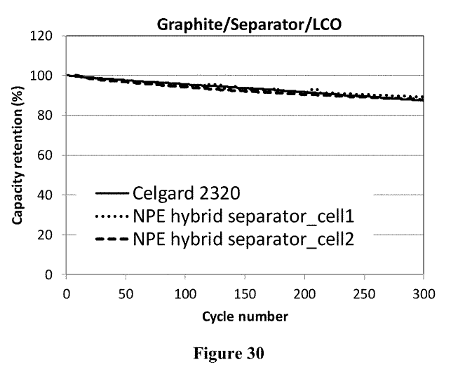

To assess the lifetime compatibility of the nanoporous electrolyte-based hybrid separator, a long-term cycle life evaluation of Li-ion full cells containing the nanoporous electrolyte hybrid separator were determined. Graphite/lithium-cobalt-oxygen coin, full cells with nanoporous electrolyte-based hybrid separator and Celgard 2320 separator (baseline) were fabricated. To expedite the cycle life evaluation, the lithium-ion full cells were cycled at higher current rates than the formation cycles, i.e., charged at 0.5C rate and discharged at 1C rate. The cycle life evaluations of the lithium-ion full cells were conducted at room temperature. FIG. 30 shows discharge capacity retention (% vs. the initial capacity) versus cycle number of the lithium-ion full cells using nanoporous electrolyte-based hybrid separator and Celgard 2320 separator (baseline). The nanoporous electrolyte hybrid separator-based lithium-ion full cells showed excellent cycle life performance with capacity retention of 88% after 300 cycles. The nanoporous electrolyte-based hybrid separator was comparable to the cycle life performance of the commercial Celgard 2320 separator. This result illustrates excellent chemical (e.g., electrolyte) and electrochemical (e.g., cycle voltage range) compatibility for the nanoporous electrolyte-based hybrid separator in lithium-ion batteries.

A number of variations and modifications of the invention can be used. It would be possible to provide for some features of the invention without providing others. The present invention, in various embodiments, configurations, or aspects, includes components, methods, processes, systems and/or apparatus substantially as depicted and described herein, including various embodiments, configurations, aspects, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A solid-state electrochemical energy storage device, comprising
a first electrode;
a second electrode;
a separator positioned between the first and second electrode; and
a solid-state electrolyte in electrolytic contact with the separator, and the first and second electrodes, wherein the separator comprises a polyethylene polymer, lithium hexafluorophate and solid electrolyte ceramic filler and wherein the solid-state electrolyte comprising a sold electrolytic ceramic filler.

2. A long-life, low voltage battery, comprising:
a cathode comprising a lithium-tin alloy having one or more of the following compositions Li₂Sn₅, LiSn, Li₁₃Sn₅, Li₇Sn₂ and Li₂₂Sn₅ and one or more of an atomic-deposited layer of a cathode active material and a conductive additive;
an anode;
a separator positioned between the cathode and anode; and
an electrolyte in electrolytic contact with the separator, and the cathode and anode.

3. A metal-sulfur battery, comprising:
a cathode comprising powdered sulfur having atomic-deposited layer of a cathode active material and one or more conductive additives;
an anode;
a separator having one or more atomic-deposited and molecular-deposited layers, wherein the separator is positioned between the cathode and anode; and
an electrolyte in electrolytic contact with the separator, and the cathode and anode.

4. A nanocomposite separator for electrochemical storage devices, composing:
a functionalized block copolymer substrate;
one or more atomic-deposited and molecular-deposited layers positioned on the functionalized block copolymer substrate;
one or more nanoceramic materials incorporated into the functionalized block copolymer substrate; and
one or more microporous separator with high porosity and mechanical and thermal durability characteristics.
